(19) United States
(12) Patent Application Publication
(10) Pub. No.: US 2026/0254544 A1
(43) Pub. Date: Aug. 27, 2026

(54) CONTROL APPARATUS, CONTROL METHOD, AND RECORDING MEDIUM

(71) Applicant: NEC Corporation, Minato-ku, Tokyo (JP)

(72) Inventor: Takeo ONISHI, Tokyo (JP)

(73) Assignee: NEC Corporation, Minato-ku, Tokyo (JP)

(21) Appl. No.: 18/726,433

(22) PCT Filed: Jan. 13, 2022
(86) PCT No.: PCT/JP2022/000933

§ 371 Date: Jul. 3, 2024

(51) Int. Cl. H04B 17/309

(52) U.S. Cl. CPC H04B 17/309

(57) ABSTRACT

In order to appropriately control communication performance between a base station and a plurality of communication terminals, while enhancing possibility to meet communication requirements for applications, a control apparatus selects one or more communication terminals being targets of communication, from among a plurality of communication terminals, by using current radio wave quality information (first radio wave quality information), past information including past radio wave quality information (second radio wave quality information), and communication requirement information and selects one or more antennas to be used when communicating with the one or more communication terminals, from among a plurality of antennas, by using the one or more communication terminals and the first radio wave quality information.

### TECHNICAL FIELD

The present disclosure relates to a control apparatus, a control method, and a recording medium.

### BACKGROUND ART

As a technique that achieves stabilization in communication and enhancement in communication quality, a scheme has been used that radio waves are simultaneously transmitted from a plurality of antennas (or antenna elements). Examples of such a scheme includes Massive Multiple Input Multiple Output (MIMO), beam forming, and the like.

MIMO is a scheme that different signals are simultaneously transmitted and received using a plurality of antennas. Thus, MIMO allows the throughput to be improved.

The beam forming is controlling that controls phases and amplitudes of radio signals transmitted or received by a plurality of antenna elements to cause the form and direction (angle) of a beam to be changed. Thus, the beam forming allows a radio wave strength in a communication terminal existing in a specific direction or specific location to be improved.

As a technique using such a scheme, distributed antenna systems (DASs) are under study. A distributed antenna system includes a control apparatus (for example, base station) and a plurality of antennas physically away from the control apparatus. With such a system, shielding can be evaded and space diversity can be provided, allowing communication quality to be further enhanced.

NPL 1 discloses an antenna selection method in a distributed antenna system. NPL 2 discloses a scheduling technique for radio resources in a distributed antenna system.

### CITATION LIST

### Patent Literature

[PTL 1] JP 2013-214896 A
[PTL 2] JP 2006-520109 T
[PTL 3] JP 2011-009964 A

### Non Patent Literature

[NPL 1] Xiaoming She, “Antenna Selection Scheme for Downlink Transmission in Distributed Antenna System”, NTT DoComo Technical Journal, Vol 15, No. 1, pp. 55.
[NPL 2] Yuki Arikawa, “Basic Study on Coordinated Radio-resource Scheduler Architecture in Ultra-high-density Distributed Antenna Systems”, IEICE Technical Report, RCS2015-375 (2016)

### SUMMARY

### Technical Problem

In a case where a control apparatus communicates with a plurality of communication terminals by using a plurality of antennas, communication requirements for respective applications that operate in the plurality of communication terminals are required to be met. However, relation (for example, positional relation, radio wave quality, or the like) between the plurality of antennas and the plurality of communication terminals can be changed at all times. The techniques in NPLs 1 and 2 have no account taken in such communication requirements for applications. Thus, in a situation where the relation is changed as described above, the techniques in NPLs 1 and 2 may not allow communication requirements for applications to be met.

The present disclosure provides a technique that appropriately controls communication performance between a control apparatus and a plurality of communication terminals, while enhancing possibility to meet communication requirements for applications.

### Solution to Problem

In one or more example embodiments, a control apparatus is provided. The control apparatus includes: a first information acquisition means for acquiring first radio wave quality information on a current radio wave quality between a plurality of communication terminals and a plurality of antennas; a second information acquisition means for acquiring communication requirement information on respective communication requirements required for the plurality of communication terminals; a storage means for storing past information including at least second radio wave quality information on a past radio wave quality between the plurality of communication terminals and the plurality of antennas; a terminal selecting means for selecting one or more communication terminals being targets of communication, from among the plurality of communication terminals, by using the past information, the first radio wave quality information, and the communication requirement information; and an antenna selecting means for selecting one or more antennas to be used when communicating with the one or more communication terminals, from among the plurality of antennas, by using the one or more communication terminals and the first radio wave quality information.

In one or more example embodiments, a control method is provided. The control method includes: acquiring first radio wave quality information on a current radio wave quality between a plurality of communication terminals and a plurality of antennas; acquiring communication requirement information on respective communication requirements required for the plurality of communication terminals; selecting one or more communication terminals being targets of communication, from among the plurality of communication terminals, by using past information including at least second radio wave quality information on a past radio wave quality between the plurality of communication terminals and the plurality of antennas, the first radio wave quality information, and the communication requirement information; and selecting one or more antennas to be used when communicating with the one or more communication terminals, from among the plurality of antennas, by using the one or more communication terminals and the first radio wave quality information.

In one or more example embodiments, a non-transitory computer-readable recording medium is provided. The non-transitory computer-readable recording medium stores thereon a program, the program causing a processor to perform: acquiring first radio wave quality information on a current radio wave quality between a plurality of communication terminals and a plurality of antennas; acquiring communication requirement information on respective communication requirements required for the plurality of communication terminals; selecting one or more communication terminals being targets of communication, from among the plurality of communication terminals, by using past information including at least second radio wave quality information on a past radio wave quality between the plurality of communication terminals and the plurality of antennas, the first radio wave quality information, and the communication requirement information; and selecting one or more antennas to be used when communicating with the one or more communication terminals, from among the plurality of antennas, by using the one or more communication terminals and the first radio wave quality information.

### Advantageous Effects of Invention

The configuration described above allows communication performance between a control apparatus and a plurality of communication terminals to be appropriately controlled, while enhancing possibility to meet communication requirements. Issues, configurations, and effects other than the above will be made clear by the following description of example embodiments.

### BRIEF DESCRIPTION OF THE DRAWINGS

FIG. 1 is a diagram illustrating an example of a radio communication system according to a first example embodiment;

FIG. 2 is a diagram illustrating an example of a configuration of a control apparatus;

FIG. 3 is a diagram illustrating an example of a configuration of an antenna;

FIG. 4 is a diagram illustrating an example of a configuration of a communication terminal;

FIG. 5 is a diagram illustrating examples of configurations of a storage section and a processing section in the control apparatus;

FIG. 6 is a diagram for conceptually describing a channel propagation matrix being an example of radio wave quality information;

FIG. 7 is a diagram conceptually illustrating an example of a data structure of communication requirement information;

FIG. 8 is a diagram conceptually illustrating an example of a data structure of past information;

FIG. 9 is a flowchart illustrating an example of a processing flow in the control apparatus;

FIG. 10 is a diagram illustrating an example of a radio communication system according to a second example embodiment;

FIG. 11 is a diagram illustrating examples of configurations of a storage section and a processing section in a control apparatus;

FIG. 12 is a diagram illustrating an example of the radio wave quality information;

FIG. 13 is a diagram illustrating an example of control information;

FIG. 14 is a diagram illustrating an example of a configuration of a base station;

FIG. 15 is a diagram illustrating an example of a configuration of a processing section of the base station;

FIG. 16 is a sequence diagram illustrating an example of a processing flow in the control apparatus and the base station;

FIG. 17 is a flowchart illustrating an example of a processing flow in the control apparatus, the processing flow performed in Step 1603 of FIG. 16;

FIG. 18 is a diagram illustrating an example of a configuration of a control apparatus according to a third example embodiment;

FIG. 19 is a flowchart illustrating an example of a processing flow in the control apparatus according to the third example embodiment; and

FIG. 20 is a diagram illustrating an example of a combination of software and hardware that implement functions of the control apparatus according to the third example embodiment.

### DESCRIPTION OF THE EXAMPLE EMBODIMENTS

Hereinafter, one or more example embodiments will be described with reference to the accompanying drawings. Note that, in the Specification and drawings, elements to which similar descriptions are applicable are denoted by the same reference signs, and overlapping descriptions are hence omitted.

Descriptions will be given in the following order.
1. Overview of Example Embodiments
2. First Example Embodiment
   2-1. Configuration of Radio Communication System
   2-2. Configuration of Control Apparatus
   2-3. Configuration of Antenna
   2-4. Configuration of Communication Terminal
   2-5. Configurations of Processing Section and Storage Section in Control Apparatus
   2-6. Examples of First Selection Processing and Second Selection Processing
   2-7. Processing Flow
   2-8. Effects
   2-9. Example Alterations
3. Second Example Embodiment
   3-1. Configuration of Radio Communication System
   3-2. Configuration of Control Apparatus
   3-3. Configuration of Base Station
   3-4. Processing Flow
   3-5. Effects
   3-6. Example Alterations
4. Third Example Embodiment
   4-1. Configuration of Control Apparatus
   4-2. Processing Flow
5. Other Example Embodiments

### 1. Overview of Example Embodiments

An overview of one or more example embodiments described below will be described.

In order to solve the issues described above, in one or more example embodiments, a control apparatus is provided. The control apparatus includes a first information acquisition section, a second information acquisition section, a storage section, a terminal selecting section, and an antenna selecting section.

The first information acquisition section acquires first radio wave quality information on a current radio wave quality between a plurality of communication terminals and a plurality of antennas. The second information acquisition section acquires communication requirement information on respective communication requirements required for the plurality of communication terminals.

The storage section stores past information including at least second radio wave quality information on a past radio wave quality between the plurality of communication terminals and the plurality of antennas.

The terminal selecting section selects one or more communication terminals being targets of communication, from among the plurality of communication terminals, by using the past information, the first radio wave quality information, and the communication requirement information.

The antenna selecting section selects one or more antennas to be used when communicating with the one or more communication terminals selected, from among the plurality of antennas, by using the one or more communication terminals selected and the first radio wave quality information.

With the configuration described above, the control apparatus can appropriately control communication performance between the control apparatus and the plurality of communication terminals, while enhancing possibility to meet communication requirements (for example, communication requirements for applications). Note that technical features of one or more example embodiments described below are not limited to the technical features described above. Furthermore, one or more example embodiments may provide another effect, instead of or in addition to the effects described above.

### 2. First Example Embodiment

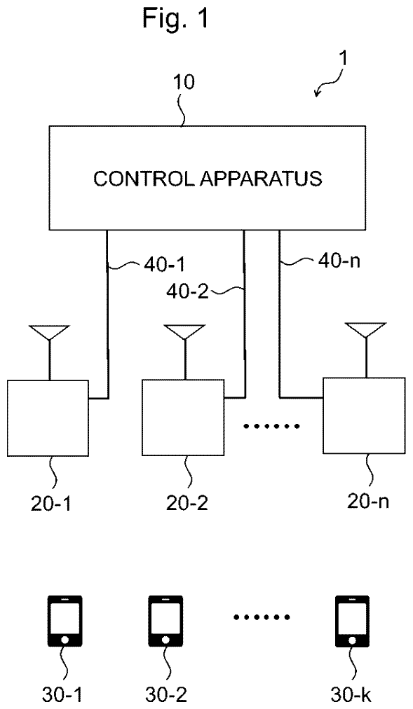

Now, a description will be given of a first example embodiment and example alterations thereof, with reference to FIGS. 1 to 9.

### 2-1. Configuration of Radio Communication System

FIG. 1 is a diagram illustrating an example of a configuration of a radio communication system 1. For example, the radio communication system 1 is a system conforming to Third Generation Partnership Project (3GPP) technical specifications. Specifically, the radio communication system 1 may be an apparatus conforming to 5th Generation (5G) technical specifications. The radio communication system 1 is, of course, not limited to these examples described above.

The radio communication system 1 includes a control apparatus 10, a plurality of antennas 20-1, . . . , 20-n, and a plurality of communication terminals 30-1, . . . , 30-k. n is an integer of two or more. k is an integer of two or more.

Hereinafter, unless the plurality of antennas 20-1, . . . , 20-n need to be distinguished from each other, one or more antennas are denoted by a reference sign “20”, for simplification of the expression. Furthermore, unless the plurality of communication terminals 30-1, . . . , 30-k need to be distinguished from each other, one or more communication terminals are denoted by a reference sign “30”.

For each of the plurality of antennas 20-1, . . . , 20-n, an identifier is allocated in advance. Hereinafter, such an identifier is referred to as an “antenna identifier”. In the present example, antenna identifiers 20-1, . . . , 20-n are allocated to the antennas 20-1, . . . , 20-n, respectively.

Furthermore, for each of the plurality of communication terminals 30-1, . . . , 30-k, an identifier is allocated in advance. Hereinafter, such an identifier is referred to as a “terminal identifier”. In the present example, terminal identifiers 30-1, . . . , 30-k are allocated to the communication terminals 30-1, . . . , 30-k, respectively. Note that the terminal identifier may be other information, as long as the terminal identifier is information capable of uniquely identifying each of the plurality of communication terminals 30. The terminal identifier may be an identifier defined in 3GPP. For example, the terminal identifier may be an International Mobile Subscription Identity (IMSI) or a Temporary Mobile Subscriber Identity (TMSI). Using such an identifier allows compatibility with an apparatus defined in 3GPP or the like to be enhanced. In another example, the terminal identifier may be an identifier such as a Media Access Control address (MAC address).

The control apparatus 10 is connected to the plurality of antennas 20-1, . . . , 20-n via a plurality of communication paths 40-1, . . . , 40-n. One or more of the plurality of antennas 20-1, . . . , 20-n are disposed at locations physically away from the control apparatus 10. Thus, in the present example, the radio communication system 1 includes a configuration of distributed antenna system (DAS).

Hereinafter, unless the plurality of communication paths 40-1, . . . , 40-n need to be distinguished from each other, one or more communication paths are denoted by a reference sign “40”.

The plurality of communication paths 40 are media used for information transmission. The plurality of communication paths 40 may be optical fibers, coaxial cables, or radio propagation paths. For example, a Radio over Fiber (RoF) technique may be applied between the control apparatus 10 and the plurality of antennas 20. In another example, a Common Public Radio Interface (CPRI) technique, an evolved Common Public Radio Interface (eCPRI) technique, or the like may be applied between the control apparatus 10 and the plurality of antennas 20.

The control apparatus 10 performs radio communication with the plurality of communication terminals 30 by using the plurality of antennas 20. Each communication terminal 30 may be referred to as a user equipment (UE), a mobile station, or the like. For example, the communication terminal 30 may be a portable terminal such as a smartphone, a portable phone, or a tablet. The communication terminal 30 may be a relay apparatus with a relay function.

Note that, hereinafter, a link where a signal is transmitted from the control apparatus 10 to the communication terminal 30 is referred to as a “downlink”. A signal transmitted on the downlink is referred to as a “downlink signal”. Furthermore, a link where a signal is transmitted from the communication terminal 30 to the control apparatus 10 is referred to as an “uplink”. A signal transmitted on the uplink is referred to as an “uplink signal”.

### 2-2. Configuration of Control Apparatus

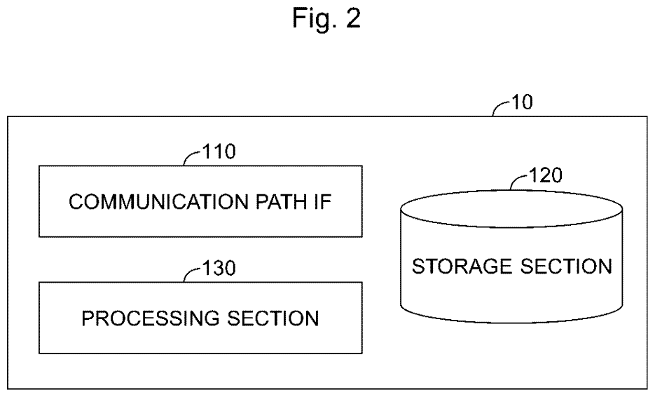

FIG. 2 is a diagram illustrating an example of a configuration of the control apparatus 10. The control apparatus 10 may be a node of a radio access network (RAN). For example, the control apparatus 10 may be a radio base station or an access point (AP). The control apparatus 10 may be a Central Unit or Centralized Unit (CU), a Distributed Unit (DU), a Radio Unit (RU), or another apparatus.

The control apparatus 10 includes a communication path interface (IF) 110, a storage section 120, and a processing section 130.

The communication path IF 110 includes an interface that performs communication with the plurality of antennas 20 via the plurality of communication paths 40.

The storage section 120 includes a volatile memory and a non-volatile memory. The volatile memory may include, for example, a Random Access Memory (RAM). The non-volatile memory may include, for example, at least one of a Read Only Memory (ROM), a Hard Disk Drive (HDD), and a Solid State Drive (SSD). The non-volatile memory stores program codes (instructions) for implementation of various functions of the control apparatus 10. Furthermore, the non-volatile memory stores information (past information described below) to be used in an operation of the control apparatus 10.

The processing section 130 includes one or more processors. The one or more processors may include, for example, at least one of a Central Processing Unit (CPU), a Micro Processing Unit (MPU), and a microcontroller. The processing section 130 executes the program codes stored in the storage section 120 to implement the various functions (functional modules described below) of the control apparatus 10.

### 2-3. Configuration of Antenna

The plurality of antennas 20-1, . . . , 20-n each have the same configuration as one another. In the following, a configuration of the antenna 20-1 is described and the description is omitted on the other antennas 20-2, . . . , 20-n.

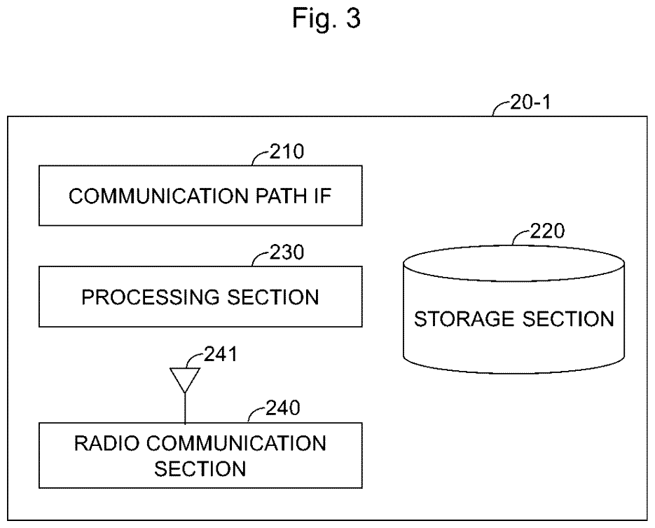

FIG. 3 is a diagram illustrating an example of the configuration of the antenna 20-1. The antenna 20-1 includes a communication path interface (IF) 210, a storage section 220, a processing section 230, and a radio communication section 240.

The communication path IF 210 is an interface for communication with the control apparatus 10 via the communication path 40-1.

The storage section 220 includes a volatile memory and a non-volatile memory. The volatile memory may include, for example, an RAM. The non-volatile memory may include, for example, at least one of an ROM, an HDD, and an SSD. The non-volatile memory stores program codes (instructions) for implementation of various functions of the antenna 20-1. The processing section 230 includes one or more processors. The one or more processors may include, for example, at least one of a CPU, an MPU, and a microcontroller. The processing section 230 executes the program codes stored in the storage section 220 to implement the various functions of the antenna 20-1.

For example, the processing section 230 performs processing of converting a baseband signal into a radio frequency signal, and processing of converting a radio frequency signal into a baseband signal.

The radio communication section 240 is an element that performs radio communication with the plurality of communication terminals 30. For example, the radio communication section 240 transmits radio frequency signals to one or more communication terminals 30 and receives radio frequency signals from one or more communication terminals 30. For example, the radio communication section 240 includes an antenna element 241.

### 2-4. Configuration of Communication Terminal

The plurality of communication terminals 30-1, . . . , 30-k each have the same configuration as one another. In the following, a configuration of the communication terminal 30-1 is described and the description is omitted on the other communication terminals 30-2, . . . , 30-k.

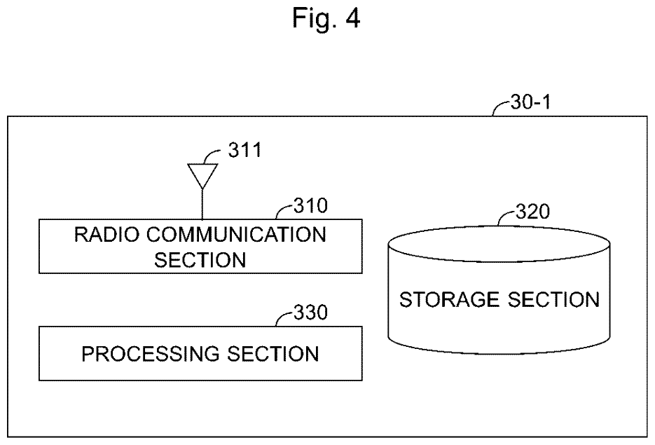

FIG. 4 is a diagram illustrating an example of the configuration of the communication terminal 30-1. The communication terminal 30-1 includes a radio communication section 310, a storage section 320, and a processing section 330.

The radio communication section 310 is an element that performs radio communication with the plurality of antennas 20. For example, the radio communication section 310 includes an antenna element 311. The radio communication section 310 may include a plurality of the antenna elements 311.

The storage section 320 includes a volatile memory and a non-volatile memory. The volatile memory may include, for example, an RAM. The non-volatile memory may include, for example, at least one of an ROM, an HDD, and an SSD. The non-volatile memory stores program codes (instructions) for implementation of various functions of the communication terminal 30-1.

The processing section 330 includes one or more processors. The one or more processors may include, for example, at least one of a CPU, an MPU, and a microcontroller. The processing section 330 executes the program codes stored in the storage section 320 to implement the various functions of the communication terminal 30-1. Specifically, the processing section 330 executes one or more applications that operate in the communication terminal 30-1.

In the present example, communication requirements for successful (or high quality) operation of the applications are configured. The communication requirements are described below in detail.

### 2-5. Configurations of Processing Section and Storage Section in Control Apparatus

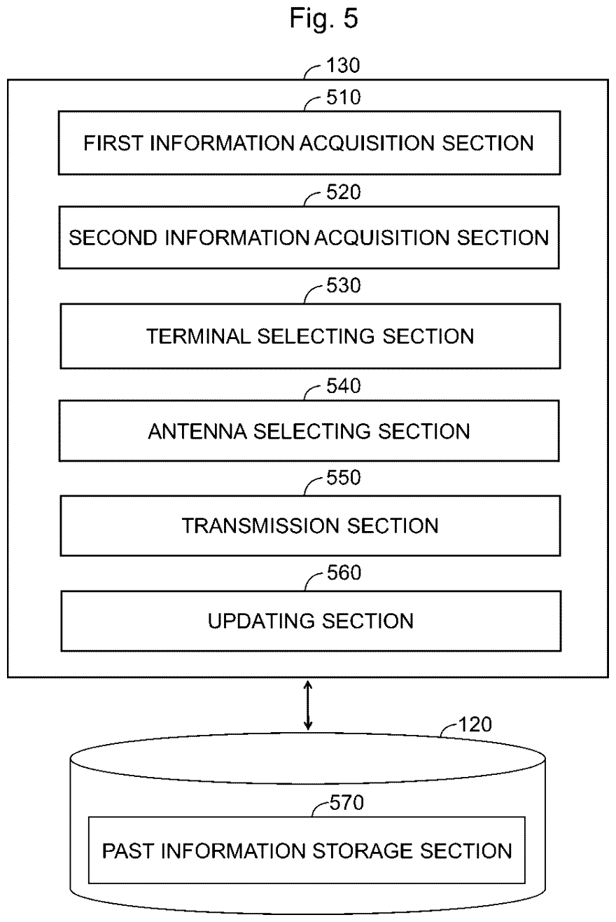

FIG. 5 is a diagram illustrating examples of configurations of the storage section 120 and the processing section 130 in the control apparatus 10.

The processing section 130 includes, as the functional modules, a first information acquisition section 510, a second information acquisition section 520, a terminal selecting section 530, an antenna selecting section 540, a transmission section 550, and an updating section 560. The storage section 120 includes a past information storage section 570.

The first information acquisition section 510 acquires information on a radio wave quality between the plurality of communication terminals 30 and the plurality of antennas 20. Hereinafter, such information is referred to as “radio wave quality information”.

Specifically, the radio wave quality information is information on radio wave qualities between the respective antenna elements 331 of the plurality of communication terminals 30 and the respective antenna elements 241 of the plurality of antennas 20. For example, the radio wave quality information may include at least one of a radio wave strength, a packet loss rate, and a channel propagation matrix.

The radio wave strength is, for example, a strength of a radio wave measured in any one communication terminal 30 of the communication terminals 30 when the communication terminal 30 receives a downlink signal. For example, the radio wave strength may be information indicating received power (for example, Reference Signal Received Power (RSRP)). The received power is, for example, measured using a synchronization signal or a reference signal. The synchronization signal may be, for example, a Secondary Synchronization Signal (SSS) of New Radio (NR). The reference signal may be, for example, a Channel State Information-Reference Signal (CSI-RS) or a Physical Broadcast Channel-Demodulation Reference Signal (PBCH-DMRS) of NR.

The packet loss rate is a rate of lost packets to transmitted packets.

The channel propagation matrix is a matrix expressing strengths of radio waves and phases thereof when the radio waves transmitted from respective ones of the plurality of antennas 20 are received by the respective antenna elements 331 of the plurality of communication terminals 30. Note that the radio wave quality information may be Precoding Matrix Indicators (PMIs) notified from respective ones of the plurality of communication terminals 30. The PMIs are values defined in 3GPP and are information that a channel propagation matrix is expressed in an index format.

In another example, the radio wave quality information may be information indicating a Reference Signal Received Quality (RSRQ), a Signal to Noise Ratio (SNR), a Signal to Interference Ratio (SIR), or a Signal to Interference plus Noise Ratio (SINR).

Note that the radio wave quality information may be information measured when the antenna(s) 20 receives an uplink signal.

The radio wave quality information may include information other than the information on the radio wave qualities. For example, the radio wave quality information may include information on locations of the plurality of communication terminals 30. The radio wave quality information may include information on respective characteristics of the plurality of antennas 20. The radio wave quality information may include weight information in a case of using two or more of the plurality of antennas 20. Such a configuration described above allows the processing section 130 to accurately calculate communication performance and a spatial correlation between the plurality of antennas 20.

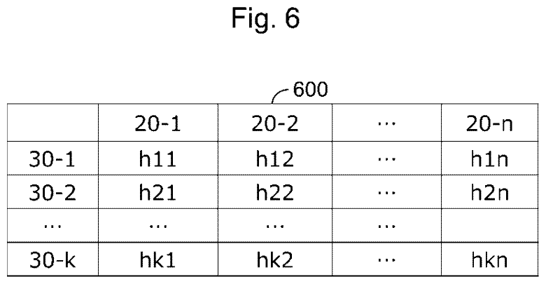

In the present example, the radio wave quality information is a channel propagation matrix. FIG. 6 is a diagram for conceptually describing a channel propagation matrix 600 being an example of the radio wave quality information. With reference to FIG. 6, the antenna identifiers are indicated in the first row of the channel propagation matrix 600. Furthermore, the terminal identifiers are indicated in the first column of the channel propagation matrix 600.

Elements h11, . . . , hkn in the table of FIG. 6 correspond to values (complex numbers) of the channel propagation matrix 600. In the present example, each of the plurality of communication terminals 30 includes one antenna element 311. Thus, one antenna identifier is associated with one terminal identifier.

As described above, one communication terminal 30 may include two or more antenna elements. In this case, the channel propagation matrix has a value for each of the antenna elements.

The second information acquisition section 520 acquires information on the communication requirements. Hereinafter, such information is referred to as “communication requirement information”. The communication requirements are respective communication requirements required for the plurality of communication terminals 30. Specifically, each communication requirement is radio communication performance required for an application that operates in a respective one of the plurality of communication terminals 30.

The communication requirement information is not limited, as long as the communication requirement information is information on such radio communication performance required for an application. For example, the communication requirement information may include at least one of a throughput, a packet communication delay, a packet loss rate, a radio resource amount, and a combination of a data amount and a time deadline for the data amount.

The radio resource amount is a radio resource amount required for an application that operates in a respective one of the plurality of communication terminals 30. Specifically, the radio resource amount includes a frequency width, a time period to occupy a specific frequency, and the like. The radio resource amount may be a “Resource Element” defined in 3GPP or a Transmission Time Interval (TTI). In another example, the radio resource amount may be a Resource Unit (RU) in a wireless LAN.

In the present example, each communication requirement is a combination of a data amount and a time deadline for the data amount. Specifically, the communication requirement is a combination of the size of a remaining data amount to be transmitted to a respective one of the plurality of communication terminals 30 and a remaining time to a deadline.

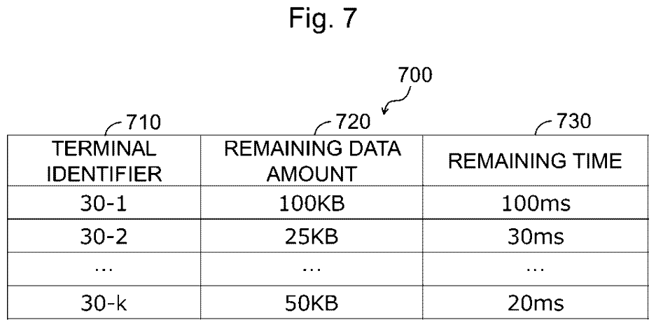

FIG. 7 is a diagram conceptually illustrating an example of a data structure of communication requirement information 700. A format of the communication requirement information 700 is not limited to a table format but may be another format.

The communication requirement information 700 includes, as the component items, a terminal identifier 710, a remaining data amount 720, and a remaining time 730. These component items are associated with each other.

The terminal identifier 710 corresponds to the terminal identifiers 30-1, . . . , 30-k described above. The remaining data amount 720 corresponds to the sizes of respective remaining data amounts to be transmitted to the plurality of communication terminals 30. The remaining time 730 corresponds to remaining times to a deadline.

In the example of FIG. 7, it is seen that data of 100 KB needs to be transmitted within 100 ms (milliseconds) in order to meet the communication requirement for the communication terminal 30 with the identifier “30-1”.

For example, the second information acquisition section 520 may acquire the communication requirement information 700 from an external node such as an application server. The second information acquisition section 520 may acquire the communication requirement information 700 by using another method or another node.

Note that the second information acquisition section 520 may estimate the communication requirement on the basis of traffic patterns of data (a pattern of transmitted data and a pattern of received data) in a respective one of the plurality of communication terminals 30. The second information acquisition section 520 may use, as the communication requirement information 700, the communication requirement such estimated.

The past information storage section 570 stores the past information including at least radio wave quality information acquired in the past. In the present example, the past information includes past radio wave quality information and communication performance information on communication performance measured or calculated at a time point when the past radio wave quality information is acquired. Furthermore, the past information includes terminal information on one or more terminals selected at the time point when the past radio wave quality information is acquired and antenna information on one or more antennas selected at the time point when the past radio wave quality information is acquired.

The radio wave quality information stored as the past information may include at least one of a radio wave strength, a packet loss rate, and a channel propagation matrix, similarly to the above. In the present example, the radio wave quality information is a channel propagation matrix, similarly to the above.

For example, the communication performance information stored as the past information may include at least one of a throughput, a communicable data amount, a frame coding rate, a modulation scheme, a frame error rate (Block Error Rate (BLER)). In the present example, the communication performance information is respective data transmission speeds (throughputs) for the plurality of communication terminals 30.

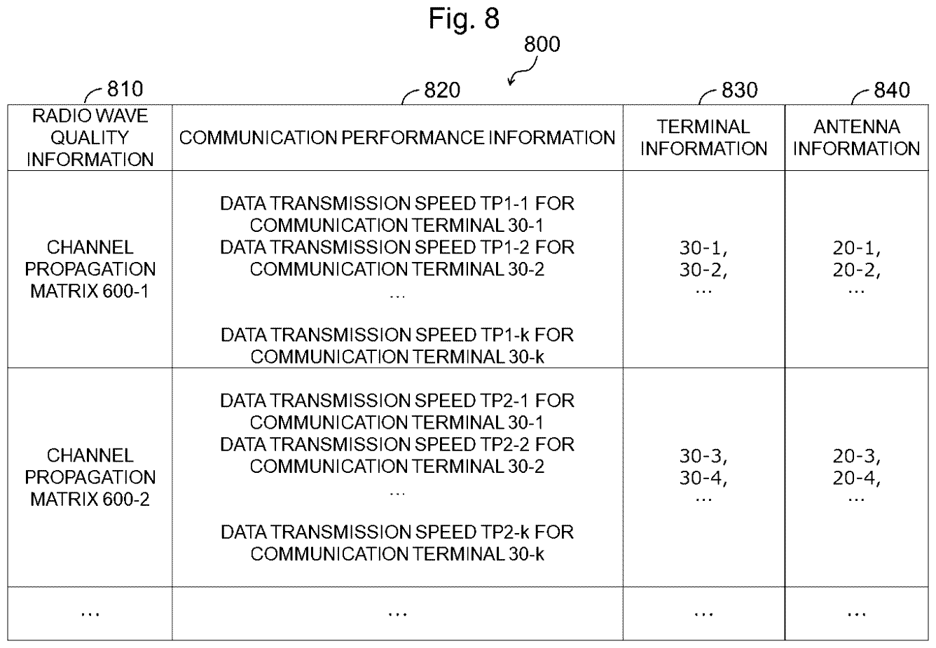

FIG. 8 is a diagram conceptually illustrating an example of a data structure of past information 800. A format of the past information 800 is not limited to a table format but may be another format.

The past information 800 includes, as the component items, radio wave quality information 810, communication performance information 820, terminal information 830, and antenna information 840. These component items, in a state of being associated with each other, are stored in the past information storage section 570.

The radio wave quality information 810 corresponds to channel propagation matrices acquired in the past. The communication performance information 820 corresponds to communication performance information calculated or measured at a time point when the radio wave quality information 810 is acquired. The terminal information 830 corresponds to the terminal identifiers of one or more terminals selected by the terminal selecting section 530 at the time point when the radio wave quality information 810 is acquired. The antenna information 840 corresponds to the antenna identifiers of one or more antennas selected by the antenna selecting section 540 at the time point when the radio wave quality information 810 is acquired.

Every time when a certain time period elapses, the terminal selecting section 530 selects N1 communication terminals being targets of communication (data transmission or data reception), from among the plurality of communication terminals 30. N1 is an integer of one or more, and here 1≤N1≤k. Hereinafter, for simplification of the description, N1 communication terminals being targets of data transmission or data reception are referred to as “one or more communication terminals 30a”. Furthermore, processing of selecting the one or more communication terminals 30a is referred to as “first selection processing”.

The antenna selecting section 540 selects N2 antennas to be used when communicating with the one or more communication terminals 30a, from among the plurality of antennas 20. N2 is an integer of one or more, and here 1≤N2≤n. In the present example, N1=N2. Note that N1 may be different from N2. Hereinafter, for simplification of the description, N2 antennas to be used when communicating with the one or more communication terminals 30a are referred to as “one or more antennas 20a”. Furthermore, processing of selecting the one or more antennas 20a is referred to as “second selection processing”.

The antenna selecting section 540 performs the second selection processing, and then decides how signals to be transmitted to the one or more communication terminals 30a are distributed to the one or more antennas 20a. Furthermore, the antenna selecting section 540 decides how the signals to be transmitted to the one or more communication terminals 30a are mixed.

For example, the one or more communication terminals 30a are assumed to be the communication terminals 30-1, 30-2, and 30-3, and the one or more antennas 20a are assumed to be the antennas 20-1, 20-2, and 20-3. Three signals, for example, s1(t), s2(t), and s3(t) are transmitted to the three communication terminals 30-1, 30-2, and 30-3. Respective signals to be transmitted from the three antennas 20-1, 20-2, and 20-3 are expressed as y1(t), y2(t), and y3(t). In this case, the relation is as follows.

$$( y 1 ( t ) , y 2 ( t ) , y 3 ( t ) ) = W ( s 1 ( t ) , s 2 ( t ) , s 3 ( t ) )$$

W is a weight matrix of 3×3. The antenna selecting section 540 may decide such a weight matrix W. Note that components of the weight matrix W are complex numbers.

Each of the one or more communication terminals 30a receives a signal obtained by synthesizing y1(t), y2(t), and y3(t). The antenna selecting section 540 decides the weight matrix W in a manner allowing each of the one or more communication terminals 30a to extract a signal addressed to the terminal itself from the synthesized signal. The antenna selecting section 540 may calculate the weight matrix W by using a method such as a Zero Forcing (ZF) method.

The transmission section 550 transmits, to the one or more antennas 20a, signals (baseband signals) to be transmitted to the one or more communication terminals 30a. The one or more antennas 20a converts the baseband signals into radio frequency signals and transmits the radio frequency signals to the one or more communication terminals 30a.

The updating section 560 updates the past information 800. The updating section 560 stores, as the past information 800, the radio wave quality information acquired by the first information acquisition section 510, the communication performance information calculated or measured, the one or more communication terminals 30a, and the one or more antennas 20a.

### 2-6. Examples of First Selection Processing and Second Selection Processing

Next, details of the first selection processing and the second selection processing will be described. In the following, the first selection processing and the second selection processing in a case of transmitting signals to the one or more communication terminals 30a will be described. Note that the first selection processing and the second selection processing described below are also applicable to a case of receiving signals from the one or more communication terminals 30a.

Hereinafter, current radio wave quality information (channel propagation matrix) acquired by the first information acquisition section 510 is referred to as “first radio wave quality information”. On the other hand, the past radio wave quality information 810 (channel propagation matrices) stored in the past information 800 is referred to as “second radio wave quality information”.

### (1) First Selection Processing

The terminal selecting section 530 selects the one or more communication terminals 30a, by using the past information 800, the first radio wave quality information, and the communication requirement information 700.

Specifically, the first information acquisition section 510 acquires the first radio wave quality information (channel propagation matrix 600). The second information acquisition section 520 acquires the communication requirement information 700 from an application server.

The terminal selecting section 530 acquires the communication requirement information 700 from the second information acquisition section 520. The terminal selecting section 530 selects N1 communication terminals from among the plurality of communication terminals 30, by using the communication requirement information 700. Here, the selected communication terminals are candidates for the one or more communication terminals 30a and are hereinafter referred to as “one or more communication terminal candidates 30b”.

Specifically, the terminal selecting section 530 selects, as the one or more communication terminal candidates 30b, communication terminals with high needs to transmit data in order to meet the communication requirements. For example, the terminal selecting section 530 may select the one or more communication terminal candidates 30b in order from one the shortest in the remaining time 730.

In another example, the terminal selecting section 530 may calculate the throughput by dividing the remaining data amount 720 by the remaining time 730. The terminal selecting section 530 may select the one or more communication terminal candidates 30b in order from one the highest in the throughput such calculated. As described above, the terminal selecting section 530 selects the one or more communication terminal candidates 30b by taking account of the communication requirements necessary for applications. Thus, this allows the communication requirements necessary for the applications to be ensured.

Next, the terminal selecting section 530 estimates first communication performance to be obtained in a case of communicating with the one or more communication terminal candidates 30b. Then, when the first communication performance estimated meets a certain first communication performance condition, the terminal selecting section 530 selects the one or more communication terminal candidates 30b as the one or more communication terminals 30a. In the present example, the first communication performance is the sum of data transmission speeds related to the one or more communication terminal candidates 30b (hereinafter referred to as “total throughput”).

The first communication performance condition is a condition related to communication performance to be met in a case of communicating with the one or more communication terminals 30a. In the present example, the first communication performance condition is a condition that the total throughput is equal to or higher than a certain first performance threshold TPth1.

Specifically, the terminal selecting section 530 acquires the first radio wave quality information from the first information acquisition section 510. The terminal selecting section 530 refers to the past information 800 to select a piece of the second radio wave quality information having the highest similarity to the first radio wave quality information. Thus, the terminal selecting section 530 may calculate the similarities between the first radio wave quality information and respective pieces of the second radio wave quality information in the past information 800, by using a known method.

In the present example, the terminal selecting section 530 selects a piece of the second radio wave quality information completely matching the first radio wave quality information. For example, it is assumed that the piece of the second radio wave quality information completely matching the first radio wave quality information is the channel propagation matrix 600-1 illustrated in FIG. 8. In this case, the terminal selecting section 530 refers to a piece of the communication performance information 820 corresponding to the channel propagation matrix 600-1.

It is assumed that the one or more communication terminal candidates 30b are the communication terminals 30-1, 30-2, and 30-k. In this case, the terminal selecting section 530 refers to the piece of the communication performance information 820 corresponding to the channel propagation matrix 600-1 and calculates (TP1-1+TP1-2+TP1-k) as the total throughput. As described above, the terminal selecting section 530 estimates the first communication performance, by using the piece of the communication performance information 820 corresponding to the channel propagation matrix 600-1.

The terminal selecting section 530 determines whether the total throughput is equal to or higher than the first performance threshold TPth1. If the total throughput is equal to or higher than the first performance threshold TPth1, the first communication performance condition is met. In this case, the terminal selecting section 530 finally selects the one or more communication terminal candidates 30b as the one or more communication terminals 30a.

In contrast, if the first communication performance condition is not met, the terminal selecting section 530 performs reselection of the one or more communication terminal candidates 30b. For example, the terminal selecting section 530 replaces one or more of the current one or more communication terminal candidates 30b with other communication terminal(s). In another example, the terminal selecting section 530 may refer to the communication requirement information 700 to select the second best N1 communication terminals 30 as the one or more communication terminal candidates 30b. This allows the rate of achieving the communication requirements to be enhanced. The terminal selecting section 530 repeats the reselection of the one or more communication terminal candidates 30b until the first communication performance condition is met.

With the configuration described above, the terminal selecting section 530 can refer to the past information 800 to select a past propagation environment (second radio wave quality information) similar to a current propagation environment (first radio wave quality information). The past information 800 includes the communication performance information 820 calculated or measured at a time point when the second radio wave quality information is acquired. This allows the terminal selecting section 530 to estimate the first communication performance by using the communication performance information 820. The terminal selecting section 530 selects the one or more communication terminal 30a such that the first communication performance estimated meets the first communication performance condition.

As described above, the terminal selecting section 530 evaluates in advance the first communication performance to be assumed with a combination of the one or more communication terminal candidates 30b. The terminal selecting section 530 can exclude a combination of communication terminals 30 with which the communication performance is difficult to be obtained for a reason such as a high spatial correlation. As a result, communication performance to be met can be achieved, while the communication requirements for the applications being met.

In the example described above, the terminal selecting section 530 searches the one or more communication terminal candidates 30b one by one by using the communication requirement information 700 to finally selects the one or more communication terminals 30a, but the present disclosure is not limited to the example.

The terminal selecting section 530 may create in advance a terminal selecting model for selection of the one or more communication terminals 30a. The terminal selecting section 530 may create the terminal selecting model by using machine learning. For example, the terminal selecting section 530 may create the terminal selecting model by learning the past information 800 (specifically, the radio wave quality information 810 and the terminal information 830) and the communication requirement information 700. The terminal selecting section 530 may input, into the terminal selecting model, parameters including the first radio wave quality information and the communication requirement information 700 to select the one or more communication terminals 30a.

The terminal selecting section 530 may create the terminal selecting model such that the first communication performance is maximized. In this case, the terminal selecting section 530 may create the terminal selecting model by learning the past information 800 (specifically, the radio wave quality information 810, the communication performance information 820, and the terminal information 830) and the communication requirement information 700.

The method of estimating the first communication performance is not limited to the example described above but may be another method. The terminal selecting section 530 may calculate the differences between the first radio wave quality information (channel propagation matrix) and pieces of the second radio wave quality information (channel propagation matrices) and select a piece of the second radio wave quality information with the sum of norms of the respective elements in the matrix being the minimum. The terminal selecting section 530 may estimate the first communication performance by using the piece of the second radio wave quality information such selected.

The terminal selecting section 530 may create in advance a first communication performance model for calculation of the first communication performance. The terminal selecting section 530 may create the first communication performance model by using machine learning. For example, the terminal selecting section 530 may create the first communication performance model by learning the past information 800 (specifically, the radio wave quality information 810, the communication performance information 820, and the terminal information 830). The terminal selecting section 530 may input, into the first communication performance model, parameters including the first radio wave quality information and the one or more communication terminal candidates 30b to estimate the first communication performance. Such a configuration described above allows the terminal selecting section 530 to accurately estimate the first communication performance.

The first communication performance is not limited to the example described above. The first communication performance may include at least one of a throughput, a communicable data amount, a frame coding rate, a modulation scheme, a frame error rate (BLER), a communication delay time, and a communication resource necessary for a communication requirement to be met. The communication resource may be, for example, a radio resource amount necessary for a communication requirement for an application to be met. The radio resource amount may be a radio resource amount (the number of TTIs) obtained by dividing the remaining data amount 720 for each of the plurality of communication terminals 30 by a transmittable data amount.

The first communication performance condition may reflect a communication requirement. For example, the first communication performance condition may further include at least one of a condition that a higher threshold for the throughput is configured for the communication terminal 30 having the remaining data amount 720 larger and a condition that a higher threshold for the throughput is configured for the communication terminal 30 having the remaining time 730 shorter. Such a configuration described above allows possibility to meet a communication requirement to be enhanced.

### (2) Second Selection Processing

After the first selection processing performed by the terminal selecting section 530, the antenna selecting section 540 performs the second selection processing. The antenna selecting section 540 selects the one or more antennas 20a by using the one or more communication terminals 30a and the first radio wave quality information.

Specifically, the antenna selecting section 540 acquires the first radio wave quality information from the first information acquisition section 510. The antenna selecting section 540 selects N2 antennas from among the plurality of antennas 20 by using the one or more communication terminals 30a and the first radio wave quality information. Here, the antennas selected are candidates for the one or more antennas 20a and are hereinafter referred to as “one or more antenna candidates 20b”.

Specifically, the antenna selecting section 540 calculates an average of radio wave strengths for the one or more communication terminals 30a on the basis of the first radio wave quality information. The antenna selecting section 540 selects the one or more antenna candidates 20b in order from one the highest in such an average.

For example, N1=N2=4 is assumed. With respect to four communication terminals 30a, the antenna selecting section 540 selects four antenna candidates 20b in order from the one the highest in the average of the radio wave strengths. With respect to the antenna 20-1, the antenna selecting section 540 calculates the average of the radio wave strengths for the four communication terminals 30a as follows. In the column of the antenna 20-1 in the first radio wave quality information (channel propagation matrix 600), the antenna selecting section 540 divides the sum of norms of values corresponding to the four communication terminals 30a by the number of the corresponding rows (i.e., four). The antenna selecting section 540 selects the four antenna candidates 20b in order from the one the highest in the average of the radio wave strengths such calculated. Such a configuration described above allows the antenna selecting section 540 to efficiently search for the one or more antenna candidates 20b.

The antenna selecting section 540 estimates second communication performance to be obtained in a case of using the one or more antenna candidates 20b for communication with the one or more communication terminals 30a. Then, when the second communication performance estimated meets a certain second communication performance condition, the antenna selecting section 540 selects the one or more antenna candidates 20b as the one or more antennas 20a.

In the present example, the second communication performance is the sum of data amounts transmittable for the one or more communication terminals 30a (hereinafter referred to as “total data amount”).

The second communication performance condition is a condition related to communication performance to be met in a case of using the one or more antennas 20a for communication with the one or more communication terminals 30a. The second communication performance condition is a condition that the total data amount is equal to or larger than a certain second performance threshold TPth2.

Specifically, the antenna selecting section 540 may calculate the total data amount as follows. Specifically, the antenna selecting section 540 calculates a method of transmitting a signal from each of the one or more antenna candidates 20b by using Zero Forcing (ZF), Minimum Mean Square Error (MMSE), or Dirty Pair Coding (DPC) method, and then calculates a data amount transmittable for each of the one or more communication terminals 30a by using Shannon's communication capacity theorem or the like.

The antenna selecting section 540 determines whether the total data amount is equal to or larger than the second performance threshold TPth2. If the total data amount is equal to or larger than the second performance threshold TPth2, the second communication performance condition is met. In this case, the antenna selecting section 540 finally selects the one or more antenna candidates 20b as the one or more antennas 20a.

In contrast, if the second communication performance condition is not met, the antenna selecting section 540 performs reselection of the one or more antenna candidates 20b. For example, the antenna selecting section 540 replaces one or more of the current one or more antenna candidates 20b with other antenna(s). In another example, the antenna selecting section 540 may select the second best N2 antennas as the one or more antenna candidates 20b on the basis of the average of the radio wave strengths. The antenna selecting section 540 repeats the reselection of the one or more antenna candidates 20b until the second communication performance condition is met.

In further another example, the antenna selecting section 540 may repeat selection of the one or more antenna candidates 20b twice or more to find one or more antenna candidates 20b with the total data amount the maximum. Such a configuration described above allows the communication performance to be enhanced.

After the second selection processing performed by the antenna selecting section 540, the transmission section 550 transmits, to the one or more antennas 20a, signals to be transmitted to the one or more communication terminals 30a.

Then, the updating section 560 updates the past information 800. Specifically, the updating section 560 stores, in the past information 800, the first radio wave quality information, information on the communication performance, the one or more communication terminals 30a, and the one or more antennas 20a, in association with each other. In other words, the updating section 560 stores the first radio wave quality information as the radio wave quality information 810 (i.e., second radio wave quality information). The updating section 560 stores the information on the communication performance as the communication performance information 820. The updating section 560 stores the one or more communication terminals 30a as the terminal information 830. The updating section 560 stores the one or more antennas 20a as the antenna information 840. With the configuration described above, the control apparatus 10 can increase the amount of information in the past information 800, while performing the first selection processing and the second selection processing.

The information stored as the communication performance information 820 may be the second communication performance calculated by the antenna selecting section 540. In another example, the updating section 560 may actually measure communication performance (for example, data transmission speed) for each of the plurality of communication terminals 30 and store, as the communication performance information 820, the data transmission speed such measured. In further another example, the updating section 560 may calculate the communication performance by using the one or more communication terminals 30a and the weight matrix described above. The updating section 560 may store, as the communication performance information 820, the communication performance such calculated.

In the example described above, the antenna selecting section 540 searches the one or more antenna candidates 20b one by one to finally select the one or more antennas 20a. The method of selecting the one or more antennas 20a is not limited to the example described above but may be another method.

The antenna selecting section 540 may select the one or more antennas 20a, on the basis of the first radio wave quality information, such that each of the one or more communication terminals 30a is allocated to an antenna the highest in the radio wave strength.

The antenna selecting section 540 may create in advance an antenna selecting model for selection of the one or more antennas 20a. The antenna selecting section 540 may create the antenna selecting model by using machine learning. For example, the antenna selecting section 540 may create the antenna selecting model by learning the past information 800 (specifically, the radio wave quality information 810, the terminal information 830, and the antenna information 840). The antenna selecting section 540 may input, into the antenna selecting model, parameters including the first radio wave quality information and the one or more communication terminals 30a to select the one or more antennas 20a. Such a configuration described above allows the antenna selecting section 540 to select the one or more antennas 20a with a smaller calculation amount.

The antenna selecting section 540 may create the antenna selecting model such that the second communication performance is maximized. In this case, the antenna selecting section 540 may create the antenna selecting model by learning the past information 800 (specifically, the radio wave quality information 810, the communication performance information 820, the terminal information 830, and the antenna information 840).

The method of estimating the second communication performance is not limited to the example described above but may be another method. The antenna selecting section 540 may create in advance a second communication performance model for calculation of the second communication performance. The antenna selecting section 540 may create the second communication performance model by using machine learning. For example, the antenna selecting section 540 may create the second communication performance model by learning the past information 800 (specifically, the radio wave quality information 810, the communication performance information 820, the terminal information 830, and the antenna information 840). The antenna selecting section 540 may input, into the second communication performance model, parameters including the first radio wave quality information, the one or more communication terminals 30a, and the one or more antenna candidates 20b to estimate the second communication performance. Such a configuration described above allows the antenna selecting section 540 to accurately estimate the second communication performance.

The second communication performance is not limited to the example described above. The second communication performance may include at least one of a throughput, a communicable data amount, a frame coding rate, a modulation scheme, a frame error rate (BLER), a communication delay time, and a communication resource necessary for a communication requirement to be met. The communication resource may be, for example, a radio resource amount necessary for a communication requirement for an application to be met. The radio resource amount may be a radio resource amount (the number of TTIs) obtained by dividing the remaining data amount 720 for each of the plurality of communication terminals 30 by a transmittable data amount.

The second communication performance condition may reflect a communication requirement. For example, the second communication performance condition may further include at least one of a condition that a higher threshold for the throughput is configured for the communication terminal 30 having the remaining data amount 720 larger and a condition that a higher threshold for the throughput is configured for the communication terminal 30 having the remaining time 730 shorter. Such a configuration described above allows possibility to meet a communication requirement to be enhanced.

### 2-7. Processing Flow

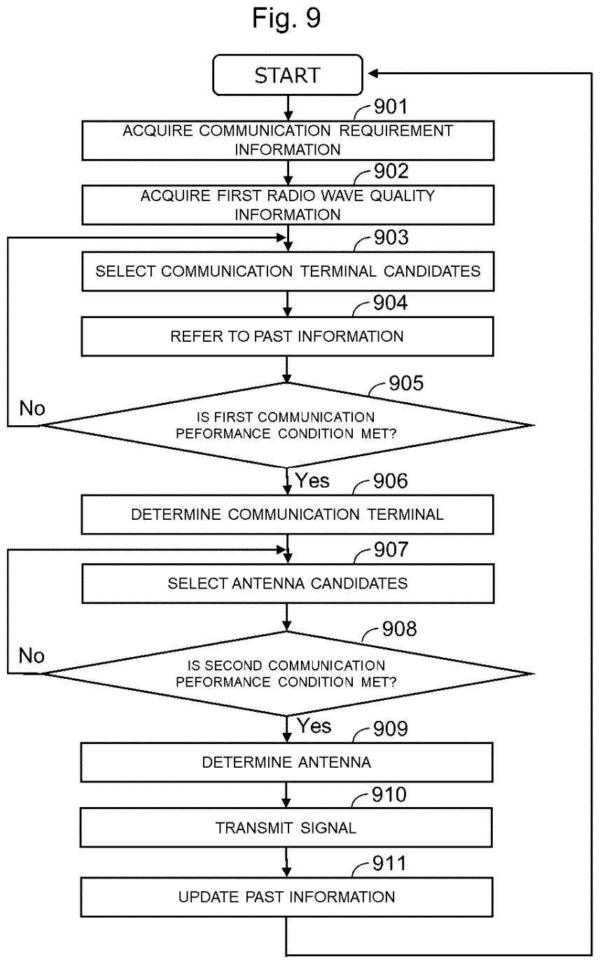

Next, a processing flow in the control apparatus 10 will be described with reference to FIG. 9. FIG. 9 is a flowchart illustrating an example of a processing flow in the control apparatus 10.

The second information acquisition section 520 acquires the communication requirement information 700 (901). The first information acquisition section 510 acquires the first radio wave quality information (channel propagation matrix 600) (902).

Next, the terminal selecting section 530 performs the first selection processing. Specifically, the terminal selecting section 530 selects, as described above, the one or more communication terminal candidates 30b (903). The terminal selecting section 530 refers to the past information 800 to select a piece of the second radio wave quality information corresponding to the first radio wave quality information (904). The terminal selecting section 530 refers to a piece of the communication performance information 820 corresponding to the piece of the second radio wave quality information selected in Step 904 to estimate the first communication performance (in the present example, total throughput). Then, the terminal selecting section 530 determines whether the first communication performance condition is met (905).

If the first communication performance condition is met (905: Yes), the terminal selecting section 530 decides the one or more communication terminal candidates 30b as the one or more communication terminals 30a (906).

In contrast, if the first communication performance condition is not met (905: No), the control apparatus 10 returns to Step 903. The terminal selecting section 530 repeats the processing from Steps 903 to 905 until the first communication performance condition is met. Note that, if the first communication performance condition is not met, the control apparatus 10 may return to Step 902 to acquire the first radio wave quality information that is the latest.

After the one or more communication terminals 30a are decided, the antenna selecting section 540 performs the second selection processing. Specifically, the antenna selecting section 540 selects, as described above, the one or more antenna candidates 20b (907). Next, the antenna selecting section 540 estimates the second communication performance (in the present example, total data amount) as described above. Then, the antenna selecting section 540 determines whether the second communication performance condition is met (908). If the second communication performance condition is met (908: Yes), the antenna selecting section 540 decides the one or more antenna candidates 20b as the one or more antennas 20a (909).

In contrast, if the second communication performance condition is not met (908: No), the control apparatus 10 returns to Step 907. The antenna selecting section 540 repeats the processing from Steps 907 to 908 until the second communication performance condition is met.

After the one or more antennas 20a are decided, the transmission section 550 transmits, to the one or more antennas 20a, signals to be transmitted to the one or more communication terminals 30a (910). Then, the updating section 560 updates, as described above, the past information 800 in the past information storage section 570 (911).

### 2-8. Effects

The configuration described above provides the following effects. The control apparatus 10 selects the one or more communication terminals 30a being targets of communication, from among the plurality of communication terminals 30, by using the past information 800, the first radio wave quality information (for example, channel propagation matrix 600), and the communication requirement information 700. Specifically, the control apparatus 10 selects the one or more communication terminal candidates 30b from among the plurality of communication terminals 30, by using the communication requirement information 700. The control apparatus 10 refers to the past information 800 to select a past propagation environment (second radio wave quality information) similar to a current propagation environment (first radio wave quality information). The past information 800 includes the communication performance information 820 calculated or measured at a time point when the second radio wave quality information is acquired. This allows the control apparatus 10 to estimate, by using the communication performance information 820, the first communication performance to be obtained in a case of communicating with the one or more communication terminal candidates 30b. Then, when the first communication performance estimated meets the first communication performance condition, the control apparatus 10 selects the one or more communication terminal candidates 30b as the one or more communication terminals 30a.

Furthermore, the control apparatus 10 selects the one or more antennas 20a from among the plurality of antennas 20 by using the one or more communication terminals 30a and the first radio wave quality information. Specifically, the control apparatus 10 selects the one or more antenna candidates 20b from among the plurality of antennas 20 by using the one or more communication terminals 30a and the first radio wave quality information. The control apparatus 10 estimates the second communication performance to be obtained in a case of using the one or more antenna candidates 20b for communication with the one or more communication terminals 30a. Then, when the second communication performance estimated meets the second communication performance condition, the control apparatus 10 selects the one or more antenna candidates 20b as the one or more antennas 20a.

With the configuration described above, the control apparatus 10 can accurately searches for “combinations between the one or more communication terminals 30a and the one or more antennas 20a” that meet the communication requirements for the applications. As a result, the control apparatus 10 can appropriately control communication performance between the control apparatus 10 and the plurality of communication terminals 30, while enhancing possibility to meet the communication requirements for the applications.

As described above, the techniques in NPLs 1 and 2 have no account taken in such communication requirements for applications. In the techniques in NPLs 1 and 2, there is a problem in that the communication requirements for the applications cannot be met and sufficient communication performance cannot be achieved. For example, with the technique in NPL 1, a combination of antennas is searched for after selection of a communication terminal. However, in the technique in NPL 1, the communication performance obtained with the combination searched for is not evaluated in advance. When the spatial correlation is high (for example, locations of communication terminals are close to each other), the communication performance may be degraded. Thus, this has a disadvantage in an example aspect of achieving the communication requirements for the applications. In contrast, the control apparatus 10 evaluates the communication performance (first communication performance and second communication performance) in advance. The control apparatus 10 can exclude a combination of communication terminals with which communication performance is difficult to be obtained for a reason such as a high spatial correlation.

### 2-9. Example Alterations

The technique according to the present disclosure is not limited to the example embodiments described above. Any two or more aspects selected from the example embodiments described above and example alterations as follows may be combined as appropriate, provided that the two or more aspects are not mutually inconsistent.

### (1) Example Alteration 1

The past information 800 is not limited to the example described above. The past information 800 may be information at least including the radio wave quality information 810. For example, in the past information 800, at least one of the communication performance information 820, the terminal information 830, and the antenna information 840 may be omitted. For example, when the past information 800 includes no communication performance information 820, the terminal selecting section 530 may calculate the first communication performance on the basis of a piece of the second radio wave quality information corresponding to the first radio wave quality information.

### (2) Example Alteration 2

The terminal selecting section 530 may adjust the number (i.e., N1) of the one or more communication terminals 30a in accordance with a utilization rate of communication resource.

The terminal selecting section 530 calculates a utilization rate of communication resource used in the last communication. For example, when the utilization rate of communication resource is lower than a certain first utilization rate threshold RUth1, the terminal selecting section 530 may increase N1. When the utilization rate of communication resource is higher than a certain second utilization rate threshold RUth2 (>RUth1), the terminal selecting section 530 may decrease N1. Such a configuration described above allows the terminal selecting section 530 to communicate with the one or more communication terminals 30a with an appropriate utilization rate of communication resource.

The terminal selecting section 530 may refer to the past information 800 to calculate the utilization rate of communication resource. For example, the terminal selecting section 530 may calculate the utilization rate of communication resource by using a piece of the second radio wave quality information corresponding to the first radio wave quality information.

### (3) Example Alteration 3

In a case where the terminal selecting model is created using machine learning, the terminal selecting section 530 may further include the following configuration. The terminal selecting section 530 may further include a learned area determination section that determines an area already learned in the terminal selecting model.

The terminal selecting model is learned using the communication requirement information 700 and the past information 800. Here, there may be a case where a learned amount is large only in a specific area (range) of parameters, while the learned amount is small in an area other than the specific area. If parameters to be input into the terminal selecting model are included in the specific area or are near the specific area, the terminal selecting model can accurately output the one or more communication terminals 30a. On the other hand, if the parameters to be input into the terminal selecting model are much away from the specific area, the terminal selecting model may not be able to accurately output the one or more communication terminals 30a.

Taking this in account, the learned area determination section determines an area (range) where the learning is being performed in the terminal selecting model. Then, based on the area where the learning is being performed, the learned area determination section adjusts the parameters (for example, the first radio wave quality information, the communication requirement information 700, and the like) to be input into the terminal selecting model. Specifically, the learned area determination section adjusts the parameters such that the parameters to be input into the terminal selecting model are included in the area or are near the area.

In another example, it is assumed that the terminal selecting model is sufficiently learned in a range where N1 is five or more and ten or less. In this case, the learned area determination section may adjust the parameters to be input into the terminal selecting model such that the terminal selecting model outputs the communication terminals 30a in a range from five to ten.

Similarly, the learned area determination section may determine an area where the learning is being performed in the antenna selecting model and adjust, based on the area where the learning is being performed, parameters to be input into the antenna selecting model.

### (4) Example Alteration 4

The antenna selecting section 540 may select the one or more antennas 20a by using the antenna information 840 in the past information 800. For example, the antenna selecting section 540 refers to the past information 800 to select a piece of the radio wave quality information 810 (second radio wave quality information) corresponding to the first radio wave quality information. The antenna selecting section 540 may select, as the one or more antennas 20a, a piece of the antenna information 840 associated with the piece of the radio wave quality information 810 such selected.

### 3. Second Example Embodiment

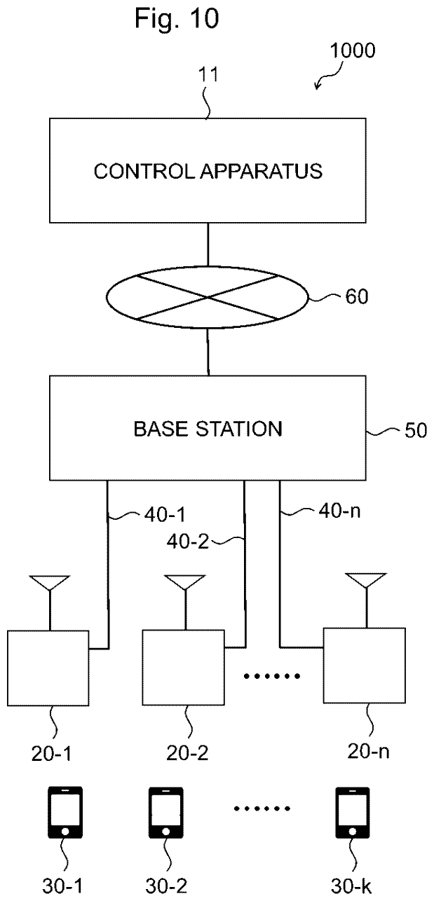

Now, a description will be given of a second example embodiment with reference to FIGS. 10 to 17. Note that, in the second example embodiment, components the same as that of the first example embodiment are denoted by the same reference signs and the description in detail on these components is omitted.

### 3-1. Configuration of Radio Communication System

FIG. 10 is a diagram illustrating an example of a configuration of a radio communication system 1000. For example, the radio communication system 1000 is a system conforming to 3GPP technical specifications. For example, the radio communication system 1000 may be a system that conforms to a technical specification of 3GPP and that conforms to a technical specification of Open RAN (O-RAN) alliance. The radio communication system 1000 is, of course, not limited to these examples.

The radio communication system 1 includes a control apparatus 11, a base station 50, a plurality of antennas 20-1, . . . , 20-n, and a plurality of communication terminals 30-1, . . . , 30-k.

The control apparatus 11 is connected to the base station 50 via a network 60. The base station 50 is connected to the plurality of antennas 20-1, . . . , 20-n via a plurality of communication paths 40-1, . . . , 40-n. One or more of the plurality of antennas 20-1, . . . , 20-n are disposed at locations physically away from the base station 50. One or more of the plurality of antennas 20-1, . . . , 20-n may be disposed at a location the same as that of the base station 50. The control apparatus 11 performs radio communication with the plurality of communication terminals 30 by using the base station 50.

In such a configuration as described above, the control apparatus 11 may be configured as a Near-Real Time RAN Intelligent Controller (Near-RT RIC) in a technical specification of O-RAN alliance. The base station 50 may be configured as an O-RAN Distributed Unit (O-DU) in a technical specification of O-RAN alliance. Each of the plurality of antennas 20-1, . . . , 20-n may be configured as an O-RAN Radio Unit (O-RU) in a technical specification of O-RAN alliance.

### 3-2. Configuration of Control Apparatus

The control apparatus 11 includes a hardware configuration (configuration in FIG. 2) similar to that of the control apparatus 10 in the first example embodiment. In other words, the control apparatus 11 includes the communication path IF 110, the storage section 120, and the processing section 130. Note that the configuration of the control apparatus 11 is different from that of the control apparatus 10 in the following point. The communication path IF 110 is an interface for communication with the base station 50 via the network 60.

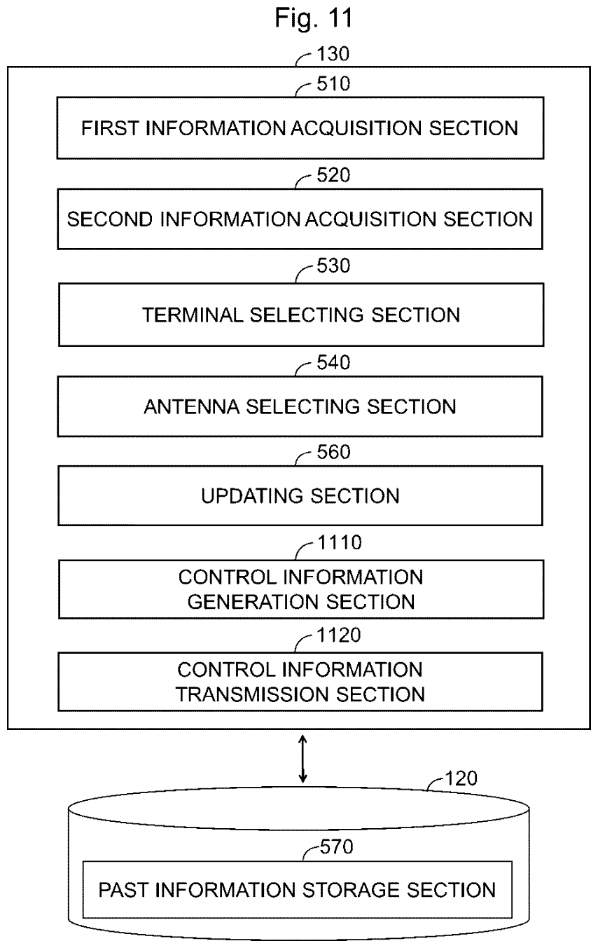

FIG. 11 is a diagram illustrating examples of configurations of the storage section 120 and the processing section 130 in the control apparatus 11.

The processing section 130 includes the first information acquisition section 510, the second information acquisition section 520, the terminal selecting section 530, the antenna selecting section 540, the updating section 560, a control information generation section 1110, and a control information transmission section 1120. The storage section 120 includes the past information storage section 570.

In the present example, as described below, the base station 50 generates current radio wave quality information (i.e., first radio wave quality information). The first information acquisition section 510 acquires the first radio wave quality information from the base station 50 via the network 60.

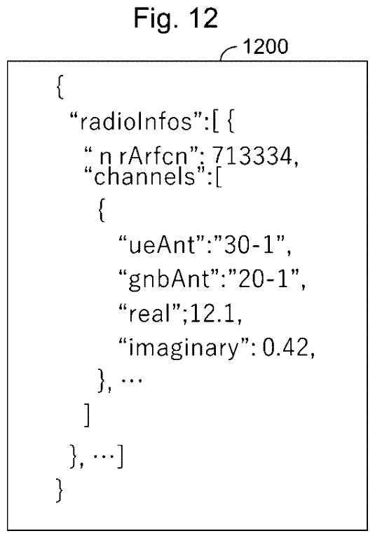

FIG. 12 is a diagram illustrating an example of radio wave quality information 1200 acquired from the base station 50. The radio wave quality information 1200 is notated with JavaScript (registered trademark) Object Notation (JSON) format. The radio wave quality information 1200 includes frequency information, a terminal identifier, an antenna identifier, and information on a channel propagation matrix.

Note that the radio wave quality information 1200 is not limited to the example described above. The radio wave quality information 1200 may include at least one of radio wave strength information such as RSRP, information on noise and interference source such as SINR, and information reflecting a congestion degree such as RSRQ. Such a configuration described above allows the terminal selecting section 530 to highly accurately select the one or more communication terminals 30a by using the radio wave quality information 1200. Furthermore, such a configuration described above allows the antenna selecting section 540 to highly accurately select the one or more antennas 20a by using the radio wave quality information 1200.

In the example of FIG. 12, the radio wave quality information 1200 is stored in association with “radioInfos” key. Under “radioInfos” key, “nrArfcn” key and “channels” key are stored. In “nrArfcn” key, a value of New Radio-Absolute Frequency Channel Number (NR-ARFCN) being utilization frequency band information of 5G is stored. In “channels” key, radio wave quality information in such a frequency band is stored.

In “ueAnt” key, an identifier uniquely identifying any one of the communication terminals 30 (or the antenna element 311 in any one of the communication terminals 30) is stored. In the present example, in “ueAnt” key, the terminal identifier 30-1 is stored.

In “gnbAnt”, an identifier uniquely identifying any one of the antennas 20 is stored. In the present example, in “gnbAnt”, the antenna identifier 20-1 is stored.

In “real” key, a real part being a component of a channel propagation matrix is stored. In “imaginary” key, an imaginary part being a component of the channel propagation matrix is stored. Note that the radio wave quality information 1200 has a sequence structure. “ . . . ” in FIG. 12 indicates that another element of the sequence is present and that the content is omitted.

The control information generation section 1110 generates control information. The control information at least includes information on the one or more antennas 20a. The control information may include other information. The control information may further include information on the one or more communication terminals 30a. Such a configuration described above allows the control apparatus 10 to collectively transmit, as the control information, the information on the one or more antennas 20a and the information on the one or more communication terminals 30a to control the one or more antennas 20a with a periodicity shorter than the communication periodicity.

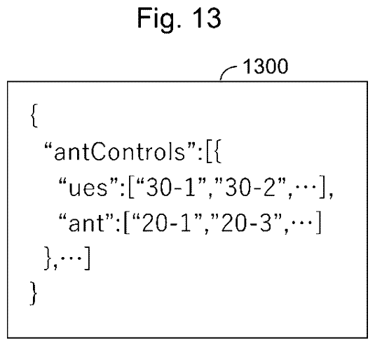

FIG. 13 is a diagram illustrating an example of control information 1300. The control information 1300 is notated with JSON format. “antControls” key indicates that this information is the control information. In “ues” key, the terminal identifiers of the one or more communication terminals 30a are stored. In “ant” key, the antenna identifiers of the one or more antennas 20a are stored. Note that “antControls” key in FIG. 13 has a sequence structure. Such a structure described above allows the control information 1300 to store a plurality of combinations between the one or more communication terminals 30a and the one or more antennas 20a.

The control information transmission section 1120 transmits the control information 1300 to the base station 50.

In the present example, the radio wave quality information 1200 and the control information 1300 are each notated with JSON format used in the Internet, but the present disclosure is not limited to this. For example, the radio wave quality information 1200 and the control information 1300 may each be notated with extensible Markup Language (XML) format. The radio wave quality information 1200 and the control information 1300 in XML format may be easily implemented by using library or the like. In another example, the radio wave quality information 1200 and the control information 1300 may each be notated with a binary format. Such a configuration described above allows the control apparatus 11 and the base station 50 to perform communication related to the radio wave quality information 1200 and the control information 1300 with a small data amount.

### 3-3. Configuration of Base Station

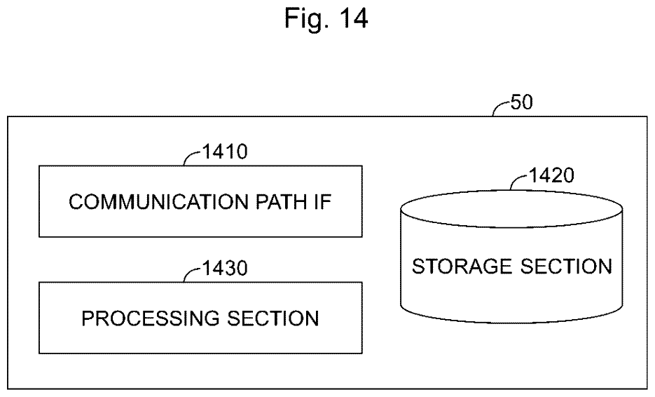

FIG. 14 is a diagram illustrating an example of a configuration of the base station 50. The base station 50 includes a communication path interface (IF) 1410, a storage section 1420, and a processing section 1430.

The communication path IF 1410 includes an interface that performs communication with the plurality of antennas 20 via the plurality of communication paths 40 and an interface that performs communication with the control apparatus 11 via the network 60.

The storage section 1420 includes a volatile memory and a non-volatile memory. The volatile memory may include, for example, an RAM. The non-volatile memory may include, for example, at least one of an ROM, an HDD, and an SSD. The non-volatile memory stores program codes (instructions) for implementation of various functions of the base station 50.

The processing section 1430 includes one or more processors. The one or more processors may include, for example, at least one of a CPU, an MPU, and a microcontroller. The processing section 1430 executes the program codes stored in the storage section 1420 to implement various functions (functional modules described below) of the base station 50.

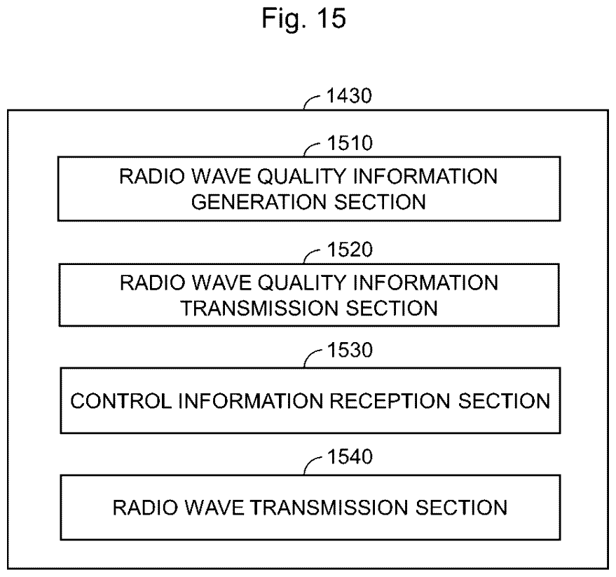

FIG. 15 is a diagram illustrating an example of a configuration of the processing section 1430 of the base station 50.

The processing section 1430 includes, as the functional modules, a radio wave quality information generation section 1510, a radio wave quality information transmission section 1520, a control information reception section 1530, and a radio wave transmission section 1540. The radio wave quality information generation section 1510 generates current radio wave quality information (first radio wave quality information).

The radio wave quality information transmission section 1520 generates, based on the radio wave quality information generated by the radio wave quality information generation section 1510, the radio wave quality information 1200 in JSON format and transmits the radio wave quality information 1200 to the control apparatus 11.

The control information reception section 1530 receives the control information 1300 in JSON format from the control apparatus 11. The control information reception section 1530 transmits the control information 1300 to the radio wave transmission section 1540. Based on the control information 1300, the radio wave transmission section 1540 transmits, to the one or more antennas 20a, signals to be transmitted to the one or more communication terminals 30a.

### 3-4. Processing Flow

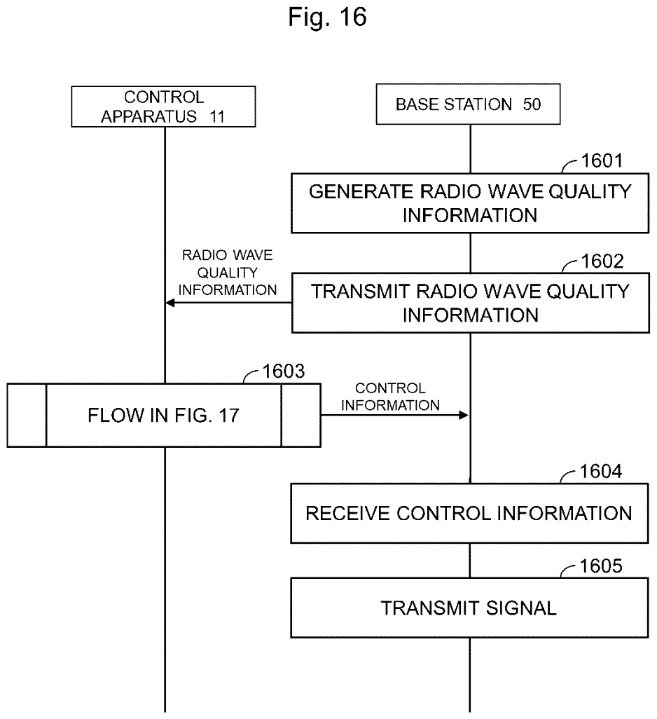

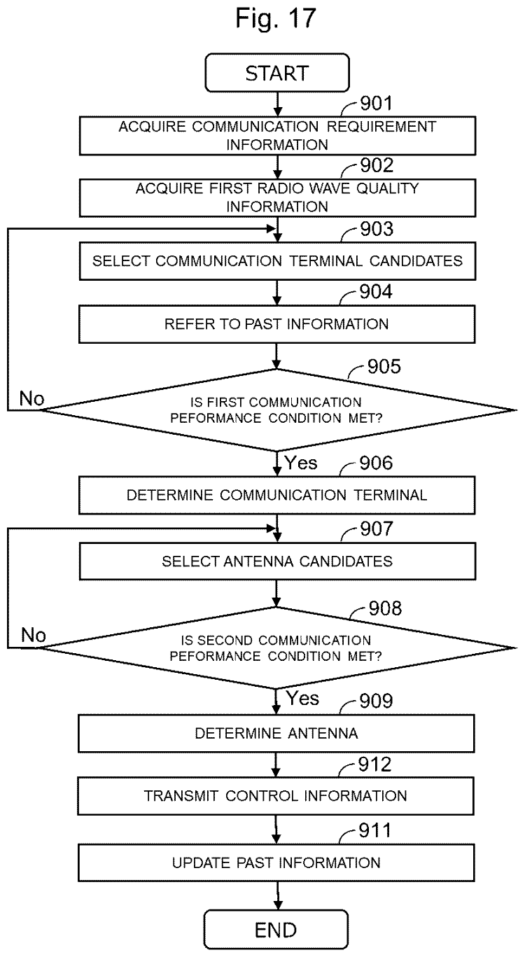

Next, a processing flow in the control apparatus 11 and the base station 50 will be described with reference to FIGS. 16 and 17. FIG. 16 is a sequence diagram illustrating an example of a processing flow in the control apparatus 11 and the base station 50.

The radio wave quality information generation section 1510 generates the current radio wave quality information (first radio wave quality information) (1601).

The radio wave quality information transmission section 1520 transmits the radio wave quality information 1200 to the control apparatus 11 (1602). The radio wave quality information transmission section 1520 may dynamically transmit the radio wave quality information 1200 at any timing from the base station 50 to the control apparatus 11. As a scheme of dynamically transmitting the radio wave quality information 1200, a protocol such as Message Queuing Telemetry Transport (MQTT) or WebSocket may be used. The radio wave quality information transmission section 1520 may transmit the radio wave quality information 1200 as a response, in response to a request from the control apparatus 11. As a scheme of transmitting the radio wave quality information 1200 as the response, a protocol such as Hypertext Transfer Protocol (HTTP) or Hypertext Transfer Protocol Secure (HTTPS) may be used. The transmission schemes described herein are only examples, and the radio wave quality information transmission section 1520 may transmit the radio wave quality information 1200 by using another scheme.

The control apparatus 11 performs the flow in FIG. 17 (1603). FIG. 17 is a flowchart illustrating an example of a processing flow in the control apparatus 11. In the flow in FIG. 17, steps where processing the same as that in FIG. 9 is performed are denoted by reference signs the same as that in FIG. 9 and the descriptions in detail of these steps are omitted.

The control apparatus 11 performs the processing of Steps 901 to 909, similarly to the first example embodiment. Thereafter, the control information generation section 1110 generates the control information 1300. Then, the control information transmission section 1120 transmits the control information 1300 to the base station 50 (912). Then, the updating section 560 updates, as described above, the past information 800 in the past information storage section 570 (911).

Note that, as a scheme of transmitting the control information 1300, similarly to Step 1602, a protocol such as MQTT or WebSocket may be used. As the scheme of transmitting the control information 1300, a protocol such as HTTP or HTTPS may be used. As the scheme of transmitting the control information 1300, another protocol may be used.

The control information reception section 1530 receives the control information 1300 from the control apparatus 11 (1604).

Based on the control information 1300, the radio wave transmission section 1540 transmits, to the one or more antennas 20a, signals to be transmitted to the one or more communication terminals 30a (1605).

### 3-5. Effects

The configuration described above provides the following effects. The control apparatus 11 is disposed at a location away from the base station 50. In addition, the control apparatus 11 receives the radio wave quality information 1200 from the base station 50 and transmits the control information 1300 to the base station 50. With the configuration described above, the control apparatus 11 performs the first selection processing and the second selection processing and the base station 50 performs processing of transmitting signals to the one or more communication terminals 30a. This allows processing with a large load to be distributed to two apparatuses as described above. In particular, the installation location and cost for the base station 50 are limited in many cases. The control apparatus 11 is disposed at a location away from the base station 50, allowing the installation location and cost to be saved.

### 3-6. Example Alterations

Example Alterations 1 to 4 described in the first example embodiment may be applied to the second example embodiment.

As described above, the control apparatus 11 and the base station 50 may each be an apparatus implemented in accordance with a technical specification of O-RAN alliance. For example, the control apparatus 11 may be a Near-RT RIC and the base station 50 may be an O-DU. With the configuration described above, the control apparatus 11 acquires the radio wave quality information 1200 from the base station 50 via an E2 interface in a technical specification of O-RAN alliance. Furthermore, the control apparatus 11 transmits the control information 1300 to the base station 50 via the E2 interface.

In another example, a part of the function of the control apparatus 11 may be implemented as a Non-Real Time RAN Intelligent Controller (Non-RT RIC) in a technical specification of O-RAN alliance. For example, at least one of a functional element that creates the terminal selecting model in the terminal selecting section 530 and a functional element that creates the first communication performance model in the terminal selecting section 530 may be implemented as a Non-RT RIC. With the configuration described above, information to be used for machine learning (for example, past information 800) may be stored in the Non-RT RIC. The Non-RT RIC creates at least one of the terminal selecting model and the first communication performance model by using machine learning. In this case, the Non-RT RIC may acquire the radio wave quality information 1200 from the base station 50 via an O1 interface in a technical specification of O-RAN alliance.

In another example, at least one of a functional element that creates the antenna selecting model in the antenna selecting section 540 and a functional element that creates the second communication performance model in the antenna selecting section 540 may be implemented as a Non-RT RIC. With the configuration described above, information to be used for machine learning (for example, past information 800) may be stored in the Non-RT RIC. The Non-RT RIC creates at least one of the antenna selecting model and the second communication performance model by using machine learning. In this case, the Non-RT RIC may acquire the radio wave quality information 1200 from the base station 50 via the O1 interface.

As described above, when a function of the control apparatus 11 is implemented by using the Near-RT RIC and the Non-RT RIC, the Near-RT RIC and the Non-RT RIC may perform communication via an A1 interface in a technical specification of O-RAN alliance. For example, the Non-RT RIC may acquire the information to be used for machine learning from the Near-RT RIC via the A1 interface. The Non-RT RIC may transmit at least one of the models described above to the Near-RT RIC via the A1 interface.

### 4. Third Example Embodiment

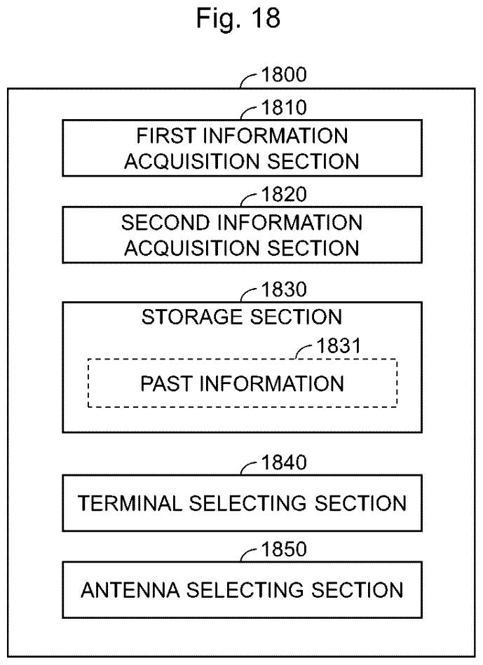

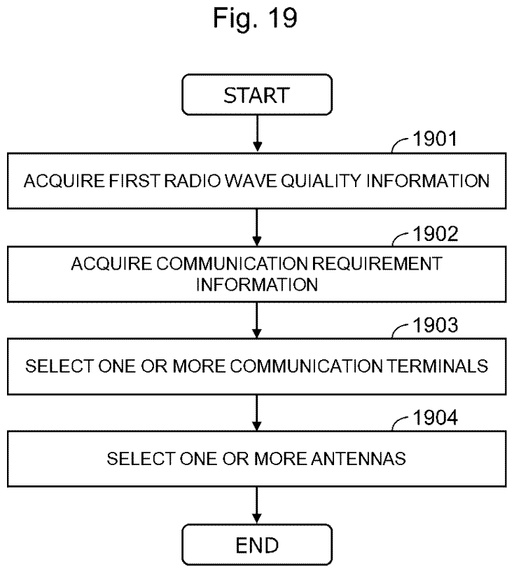

Now, a description will be given of a third example embodiment with reference to FIGS. 18 to 19. The above-described first and second example embodiments are each a concrete example embodiment, whereas the third example embodiment is a more generalized example embodiment.

### 4-1. Configuration of Control Apparatus

FIG. 18 is a diagram illustrating an example of a configuration of the control apparatus 1800. The control apparatus 1800 includes, as the functional modules, a first information acquisition section 1810, a second information acquisition section 1820, a storage section 1830, a terminal selecting section 1840, and an antenna selecting section 1850.

The functional modules 1810 to 1850 included in the control apparatus 1800 may be implemented by one or more processors and/or a memory. The one or more processors may include, for example, at least one of a CPU, an MPU, and a microcontroller. The memory may include a volatile memory and a non-volatile memory. The memory may store program codes (instructions). The one or more processors may execute the program codes stored in the memories to implement the functional modules (for example, the first information acquisition section 1810, the second information acquisition section 1820, the terminal selecting section 1840, and the antenna selecting section 1850) of the control apparatus 1800. Furthermore, a part of the memory may implement the storage section 1830.

The first information acquisition section 1810 acquires first radio wave quality information on a current radio wave quality between a plurality of communication terminals and a plurality of antennas. The second information acquisition section 1820 acquires communication requirement information on respective communication requirements required for the plurality of communication terminals. The storage section 1830 stores past information 1831 including at least second radio wave quality information on a past radio wave quality between the plurality of communication terminals and the plurality of antennas.

The terminal selecting section 1840 selects one or more communication terminals being targets of communication, from among the plurality of communication terminals, by using the past information 1831, the first radio wave quality information, and the communication requirement information. The antenna selecting section 1850 selects one or more antennas to be used when communicating with the one or more communication terminals, from among the plurality of antennas, by using the one or more communication terminals and the first radio wave quality information.

The first information acquisition section 1810 may operate similarly to the first information acquisition section 510 described above. The second information acquisition section 1820 may operate similarly to the second information acquisition section 520 described above. The storage section 1830 may have a configuration the same as that of the past information storage section 570 described above. The terminal selecting section 1840 may operate similarly to the terminal selecting section 530 described above. The antenna selecting section 1850 may operate similarly to the antenna selecting section 540 described above.

### 4-2. Processing Flow

FIG. 19 is a flowchart for describing an example of a processing flow in the control apparatus 1800.

The first information acquisition section 1810 acquires the first radio wave quality information (1901). The second information acquisition section 1820 acquires the communication requirement information (1902). The terminal selecting section 1840 selects one or more communication terminals being targets of communication, from among the plurality of communication terminals, by using the past information 1831, the first radio wave quality information, and the communication requirement information (1903). The antenna selecting section 1850 selects one or more antennas to be used when communicating with the one or more communication terminals, from among the plurality of antennas, by using the one or more communication terminals selected in Step 1903 and the first radio wave quality information (1904).

With the configuration described above, the control apparatus 1800 can appropriately control communication performance between the control apparatus 1800 and the plurality of communication terminals, while enhancing possibility to meet the communication requirements.

### 5. Other Example Embodiments

Note that the example embodiments and example alterations described above are only examples and the scope of technical spirit of the present disclosure is not limited to the configurations described above. Other aspects conceivable within the scope of technical spirit of the present disclosure are also included in the scope of the present disclosure.

The processing steps illustrated in the flowcharts may not need to be performed in the order as illustrated. The processing steps may be performed in an order different from that as illustrated. Two or more processing steps may be performed in parallel. A part of the processing steps may be deleted, or a further step may be added.

A function of the apparatuses (for example, the control apparatuses 10, 11, and 1800) described in the Specification may be implemented by any one of software, hardware, and a combination of software and hardware. Program codes (instructions) included in the software may be, for example, stored in a computer-readable recording medium inside or outside of each apparatus and may be, in the execution, read in a memory and executed by a processor. Moreover, a non-transitory computer-readable recording medium (non-transitory computer readable medium) having recorded thereon the program codes may be provided.

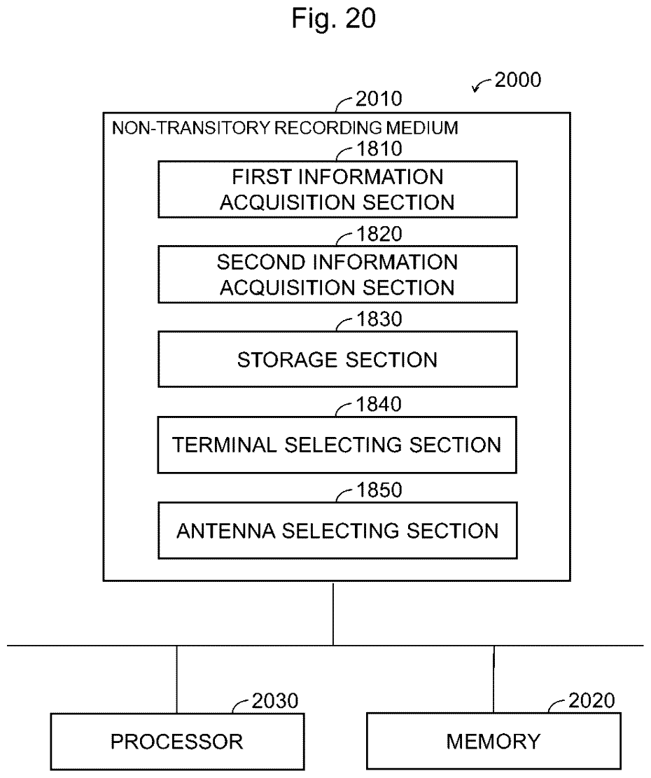

For example, FIG. 20 is an example illustrating a combination of software and hardware that implement a function of the control apparatus 1800. The information processing apparatus 2000 includes a non-transitory recording medium 2010, a memory 2020, and a processor 2030. These components are connected to each other via an internal bus. A part of the non-transitory recording medium 2010 is configured as the storage section 1830. The non-transitory recording medium 2010 stores program codes that implement the functional modules (the first information acquisition section 1810, the second information acquisition section 1820, the terminal selecting section 1840, and the antenna selecting section 1850) of the control apparatus 1800. The program codes are read out to the memory 2020. The processor 2030 executes the program codes read out to the memory 2020 to implement processing of the functional modules.

The whole or part of the example embodiments disclosed above can be described as in the following supplementary notes, but are not limited to the following.

### (Supplementary Note 1)

A control apparatus comprising:
a first information acquisition means for acquiring first radio wave quality information on a current radio wave quality between a plurality of communication terminals and a plurality of antennas;
a second information acquisition means for acquiring communication requirement information on respective communication requirements required for the plurality of communication terminals;
a storage means for storing past information including at least second radio wave quality information on a past radio wave quality between the plurality of communication terminals and the plurality of antennas;
a terminal selecting means for selecting one or more communication terminals being targets of communication, from among the plurality of communication terminals, by using the past information, the first radio wave quality information, and the communication requirement information; and
an antenna selecting means for selecting one or more antennas to be used when communicating with the one or more communication terminals, from among the plurality of antennas, by using the one or more communication terminals and the first radio wave quality information.

### (Supplementary Note 2)

The control apparatus according to Supplementary Note 1, wherein
the terminal selecting means is configured to
   select one or more communication terminal candidates, from among the plurality of communication terminals, by using the communication requirement information,
   estimate first communication performance to be obtained in a case of communicating with the one or more communication terminal candidates, and
   select, when the first communication performance meets a certain first communication performance condition, the one or more communication terminal candidates as the one or more communication terminals.

### (Supplementary Note 3)

The control apparatus according to Supplementary Note 2, wherein
the terminal selecting means is configured to
   refer to the past information to select a piece of the second radio wave quality information corresponding to the first radio wave quality information, and
   estimate, by using the piece of the second radio wave quality information selected, the first communication performance.

### (Supplementary Note 4)

The control apparatus according to Supplementary Note 3, wherein
the past information further includes communication performance information on communication performance measured or calculated at a time point when the second radio wave quality information is acquired, and
the terminal selecting means is configured to estimate, by using a piece of the communication performance information corresponding to the piece of the second radio wave quality information selected, the first communication performance.

### (Supplementary Note 5)

The control apparatus according to Supplementary Note 2, wherein
the past information further includes terminal information on the one or more communication terminals selected at a time point when the second radio wave quality information is acquired and communication performance information on communication performance measured or calculated at the time point when the second radio wave quality information is acquired,
the terminal selecting means is configured to input, into a model created in advance, parameters including the first radio wave quality information and the one or more communication terminal candidates to estimate the first communication performance, and
the model is a model created by learning the past information.

### (Supplementary Note 6)

The control apparatus according to any one of Supplementary Notes 2 to 5, wherein
the first communication performance includes at least one of a throughput, a communicable data amount, a frame coding rate, a modulation scheme, a frame error rate, a communication delay time, or a communication resource necessary for any one of the communication requirements to be met.

### (Supplementary Note 7)

The control apparatus according to any one of Supplementary Notes 2 to 6, wherein
the terminal selecting means is configured to adjust, in accordance with a utilization rate of communication resource, the number of the one or more communication terminals.

### (Supplementary Note 8)

The control apparatus according to Supplementary Note 1, wherein
the past information further includes terminal information on the one or more communication terminals selected at a time point when the second radio wave quality information is acquired,
the terminal selecting means is configured to input, into a model created in advance, parameters including the first radio wave quality information and the communication requirement information to select the one or more communication terminals, and
the model is a model created by learning the past information and the communication requirement information.

### (Supplementary Note 9)

The control apparatus according to Supplementary Note 8, further comprising:
a learned area determination means for determining an area where learning is being performed in the model and adjusting, based on the area, the parameters input into the model.

### (Supplementary Note 10)

The control apparatus according to any one of Supplementary Notes 1 to 9, wherein
the antenna selecting means is configured to
   select one or more antenna candidates, from among the plurality of antennas, by using the one or more communication terminals and the first radio wave quality information,
   estimate second communication performance to be obtained in a case of using the one or more antenna candidates for communication with the one or more communication terminals, and
   select, when the second communication performance meets a certain second communication performance condition, the one or more antenna candidates as the one or more antennas.

### (Supplementary Note 11)

The control apparatus according to Supplementary Note 10, wherein
the past information further includes the communication performance information on the communication performance measured or calculated at the time point when the second radio wave quality information is acquired, the terminal information on the one or more communication terminals selected at the time point when the second radio wave quality information is acquired, and antenna information on the one or more antennas selected at the time point when the second radio wave quality information is acquired,
the antenna selecting means is configured to input, into a model created in advance, parameters including the first radio wave quality information, the one or more communication terminals, and the one or more antenna candidates to estimate the second communication performance, and
the model is a model created by learning the past information.

### (Supplementary Note 12)

The control apparatus according to Supplementary Note 10 or 11, wherein
the second communication performance includes at least one of a throughput, a communicable data amount, a frame coding rate, a modulation scheme, a frame error rate, a communication delay time, or a communication resource necessary for any one of the communication requirements to be met.

### (Supplementary Note 13)

The control apparatus according to any one of Supplementary Notes 1 to 9, wherein
the past information further includes the terminal information on the one or more communication terminals selected at the time point when the second radio wave quality information is acquired and antenna information on the one or more antennas selected at the time point when the second radio wave quality information is acquired,
the antenna selecting means is configured to input, into a model created in advance, parameters including the one or more communication terminals and the first radio wave quality information to select the one or more antennas, and
the model is a model created by learning the past information.

### (Supplementary Note 14)

The control apparatus according to Supplementary Note 13, further comprising:
a learned area determination means for determining a learned area in the model and adjusting, based on the learned area, the parameters input into the model.

### (Supplementary Note 15)

The control apparatus according to any one of Supplementary Notes 1 to 9, wherein
the past information further includes antenna information on one or more antennas selected at the time point when the second radio wave quality information is acquired, and
the antenna selecting means is configured to
   refer to the past information to select a piece of the second radio wave quality information corresponding to the first radio wave quality information, and
   select, by using a piece of the antenna information corresponding to the piece of the second radio wave quality information selected, the one or more antennas.

### (Supplementary Note 16)

The control apparatus according to any one of Supplementary Notes 1 to 15, further comprising:

an updating means for storing, in the past information, at least the first radio wave quality information as the second radio wave quality information.

### (Supplementary Note 17)

The control apparatus according to any one of Supplementary Notes 1 to 16, wherein
the control apparatus is connected to a base station connected to the plurality of antennas, and
the first information acquisition means is configured to acquire the first radio wave quality information from the base station.

### (Supplementary Note 18)

The control apparatus according to Supplementary Note 17, further comprising:
a transmission means for transmitting, to the base station, control information including information on the one or more communication terminals and information on the one or more antennas.

### (Supplementary Note 19)

The control apparatus according to Supplementary Note 18, wherein
the first radio wave quality information and the control information are notated with a JavaScript Object Notation (JSON) format, an eXtensible Markup Language (XML) format, or a binary format.

### (Supplementary Note 20)

The control apparatus according to any one of Supplementary Notes 17 to 19, wherein
the control apparatus is configured as a Near-Real Time RAN Intelligent Controller (Near-RT RIC) in a technical specification of Open RAN (O-RAN) alliance.

### (Supplementary Note 21)

The control apparatus according to any one of Supplementary Notes 1 to 20, wherein
the communication requirements include at least one of a throughput, a packet communication delay, a packet loss rate, a radio resource amount, and a combination of a data amount and a time deadline for the data amount.

### (Supplementary Note 22)

The control apparatus according to any one of Supplementary Notes 1 to 21, wherein
each of the first radio wave quality information and the second radio wave quality information includes at least one of a radio wave strength, a packet loss rate, and a channel propagation matrix.

### (Supplementary Note 23)

A control method comprising:
acquiring first radio wave quality information on a current radio wave quality between a plurality of communication terminals and a plurality of antennas;
acquiring communication requirement information on respective communication requirements required for the plurality of communication terminals;
selecting one or more communication terminals being targets of communication, from among the plurality of communication terminals, by using past information including at least second radio wave quality information on a past radio wave quality between the plurality of communication terminals and the plurality of antennas, the first radio wave quality information, and the communication requirement information; and
selecting one or more antennas to be used when communicating with the one or more communication terminals, from among the plurality of antennas, by using the one or more communication terminals and the first radio wave quality information.

### (Supplementary Note 24)

A non-transitory computer-readable recording medium having recorded thereon a program, the program causing a processor to perform:
acquiring first radio wave quality information on a current radio wave quality between a plurality of communication terminals and a plurality of antennas;
acquiring communication requirement information on respective communication requirements required for the plurality of communication terminals;
selecting one or more communication terminals being targets of communication, from among the plurality of communication terminals, by using past information including at least second radio wave quality information on a past radio wave quality between the plurality of communication terminals and the plurality of antennas, the first radio wave quality information, and the communication requirement information; and
selecting one or more antennas to be used when communicating with the one or more communication terminals, from among the plurality of antennas, by using the one or more communication terminals and the first radio wave quality information.

Note that one or more processors may execute the program codes (instructions) stored in the memory to implement processing described in the supplementary notes 1 to 24.

### INDUSTRIAL APPLICABILITY

The control apparatus in the present disclosure is applicable to a base station apparatus or an access point that is connected to a plurality of antennas. The control apparatus in the present disclosure is applicable to an apparatus physically away from a base station or an access point that is connected to a plurality of antennas. The control apparatus in the present disclosure is applicable to a cloud-type radio system such as that at least a part of the processing part is disposed on the cloud.

### REFERENCE SIGNS LIST

1 Radio Communication System
10 Control Apparatus
20 Antenna
30 Communication Terminal
510 First Information Acquisition Section
520 Second Information Acquisition Section
530 Terminal Selecting Section
540 Antenna Selecting Section
550 Transmission Section
560 Updating Section
570 Past Information Storage Section

What is claimed is:

1-24. (canceled)

25. A control method comprising:
acquiring first radio wave quality information on a current radio wave quality between a plurality of communication terminals and a plurality of antennas;
acquiring communication requirement information on respective communication requirements required for the plurality of communication terminals;
selecting one or more communication terminals being targets of communication, from among the plurality of communication terminals, by using past information including at least second radio wave quality information on a past radio wave quality between the plurality of communication terminals and the plurality of antennas, the first radio wave quality information, and the communication requirement information; and
selecting one or more antennas to be used when communicating with the one or more communication terminals, from among the plurality of antennas, by using the one or more communication terminals and the first radio wave quality information.

26. The control method according to claim 25, further comprising:
selecting one or more communication terminal candidates, from among the plurality of communication terminals, by using the communication requirement information,
estimating first communication performance to be obtained in a case of communicating with the one or more communication terminal candidates, and
selecting, when the first communication performance meets a certain first communication performance condition, the one or more communication terminal candidates as the one or more communication terminals.

27. The control method according to claim 26, further comprising
referring to the past information to select a piece of the second radio wave quality information corresponding to the first radio wave quality information, and
estimating, by using the piece of the second radio wave quality information selected, the first communication performance.

28. The control method according to claim 27, wherein
the past information further includes communication performance information on communication performance measured or calculated at a time point when the second radio wave quality information is acquired, and
the control method further comprises estimating, by using a piece of the communication performance information corresponding to the piece of the second radio wave quality information selected, the first communication performance.

29. The control method according to claim 26, wherein
the past information further includes terminal information on the one or more communication terminals selected at a time point when the second radio wave quality information is acquired and communication performance information on communication performance measured or calculated at the time point when the second radio wave quality information is acquired,
the control method further comprises inputting, into a model created in advance, parameters including the first radio wave quality information and the one or more communication terminal candidates to estimate the first communication performance, and
the model is a model created by learning the past information.

30. The control method according to claim 26, wherein
the first communication performance includes at least one of a throughput, a communicable data amount, a frame coding rate, a modulation scheme, a frame error rate, a communication delay time, or a communication resource necessary for any one of the communication requirements to be met.

31. The control method according to claim 26, further comprising
adjusting, in accordance with a utilization rate of communication resource, the number of the one or more communication terminals.

32. The control method according to claim 25, wherein
the past information further includes terminal information on the one or more communication terminals selected at a time point when the second radio wave quality information is acquired,
the control method further comprises inputting, into a model created in advance, parameters including the first radio wave quality information and the communication requirement information to select the one or more communication terminals, and
the model is a model created by learning the past information and the communication requirement information.

33. The control method according to claim 32, further comprising:
determining an area where learning is being performed in the model and adjusting, based on the area, the parameters input into the model.

34. The control method according to claim 25, further comprising:
selecting one or more antenna candidates, from among the plurality of antennas, by using the one or more communication terminals and the first radio wave quality information,
estimating second communication performance to be obtained in a case of using the one or more antenna candidates for communication with the one or more communication terminals, and
selecting, when the second communication performance meets a certain second communication performance condition, the one or more antenna candidates as the one or more antennas.

35. The control method according to claim 34, wherein
the past information further includes the communication performance information on the communication performance measured or calculated at the time point when the second radio wave quality information is acquired, the terminal information on the one or more communication terminals selected at the time point when the second radio wave quality information is acquired, and antenna information on the one or more antennas selected at the time point when the second radio wave quality information is acquired,
the control method further comprises inputting, into a model created in advance, parameters including the first radio wave quality information, the one or more communication terminals, and the one or more antenna candidates to estimate the second communication performance, and
the model is a model created by learning the past information.

36. The control method according to claim 34, wherein
the second communication performance includes at least one of a throughput, a communicable data amount, a frame coding rate, a modulation scheme, a frame error rate, a communication delay time, or a communication resource necessary for any one of the communication requirements to be met.

37. The control method according to claim 25, wherein
the past information further includes the terminal information on the one or more communication terminals selected at the time point when the second radio wave quality information is acquired and antenna information on the one or more antennas selected at the time point when the second radio wave quality information is acquired,
the control method further comprises inputting, into a model created in advance, parameters including the one or more communication terminals and the first radio wave quality information to select the one or more antennas, and
the model is a model created by learning the past information.

38. The control method according to claim 37, further comprising:
determining a learned area in the model and adjusting, based on the learned area, the parameters input into the model.

39. The control method according to claim 25, wherein
the past information further includes antenna information on one or more antennas selected at the time point when the second radio wave quality information is acquired, and
the control method further comprises:
referring to the past information to select a piece of the second radio wave quality information corresponding to the first radio wave quality information, and
selecting, by using a piece of the antenna information corresponding to the piece of the second radio wave quality information selected, the one or more antennas.

40. The control method according to claim 25, further comprising:
storing, in the past information, at least the first radio wave quality information as the second radio wave quality information.

41. The control method according to claim 25, further comprising:
acquiring the first radio wave quality information from a base station connected to the plurality of antennas.

42. The control method according to claim 41, further comprising:
transmitting, to the base station, control information including information on the one or more communication terminals and information on the one or more antennas.

43. A control apparatus comprising:
one or more memories storing an instruction; and
one or more processors configured to execute the instruction to
acquire first radio wave quality information on a current radio wave quality between a plurality of communication terminals and a plurality of antennas;
acquire communication requirement information on respective communication requirements required for the plurality of communication terminals;
store, in the memories, past information including at least second radio wave quality information on a past radio wave quality between the plurality of communication terminals and the plurality of antennas;
select one or more communication terminals being targets of communication, from among the plurality of communication terminals, by using the past information, the first radio wave quality information, and the communication requirement information; and
select one or more antennas to be used when communicating with the one or more communication terminals, from among the plurality of antennas, by using the one or more communication terminals and the first radio wave quality information.

44. A non-transitory computer-readable recording medium having recorded thereon a program, the program causing a processor to perform:
acquiring first radio wave quality information on a current radio wave quality between a plurality of communication terminals and a plurality of antennas;
acquiring communication requirement information on respective communication requirements required for the plurality of communication terminals;
selecting one or more communication terminals being targets of communication, from among the plurality of communication terminals, by using past information including at least second radio wave quality information on a past radio wave quality between the plurality of communication terminals and the plurality of antennas, the first radio wave quality information, and the communication requirement information; and
selecting one or more antennas to be used when communicating with the one or more communication terminals, from among the plurality of antennas, by using the one or more communication terminals and the first radio wave quality information.
